(19) United States
(12) Patent Application Publication
(10) Pub. No.: US 2010/0126834 A1
(43) Pub. Date: May 27, 2010

(54) SWITCH AND ESD PROTECTION ELEMENT

(76) Inventor: Tamio IKEHASHI, Yokohama-shi (JP)

Correspondence Address: OBLON, SPIVAK, MCCLELLAND MAIER & NEUSTADT, L.L.P., 1940 DUKE STREET, ALEXANDRIA, VA, 22314, US

(21) Appl. No.: 12/563,433

(22) Filed: Sep. 21, 2009

(30) Foreign Application Priority Data
Nov. 27, 2008 (JP) 2008-302759

(51) Int. Cl. H01H 57/00

(52) U.S. Cl. 200/181

(57) ABSTRACT

The switch of an aspect of the present invention including first and second electrodes provided on a substrate, an anchor provided on the first electrode, a movable structure of which a first end is supported by the anchor, extending from the anchor to a position above the second electrode, using a conductor, and configured to move in a vertical direction with respect to the second electrode, a contact portion provided at a second end of the movable structure and disposed above the second electrode, a film having a different stress value with respect to the stress value of the movable structure, and warping the contact portion toward the second electrode, and a cap provided on the substrate to cover the movable structure, configured to be in contact with the film, and functioning as a driving electrode.

### CROSS-REFERENCE TO RELATED APPLICATIONS

This application is based upon and claims the benefit of priority from prior Japanese Patent Application No. 2008-302759, filed Nov. 27, 2008, the entire contents of which are incorporated herein by reference.

### BACKGROUND

As devices using micro-electro-mechanical systems (MEMS), a variable capacitor, a switch, an acceleration sensor, a pressure sensor, a radio frequency (RF) filter, a gyroscope, a mirror device and the like are mainly investigated and developed.

Among these devices, the MEMS switch does not cause any leakage when the switch turns off, and hence the switch is effective for reducing the power consumption (electric current consumption) of a chip. Moreover, the MEMS switch can be formed on interconnection layers of a semiconductor integrated circuit (IC), and hence a chip area can be reduced as compared with a case where an element or a circuit formed on the surface of a wafer (the chip) is used as the switch as in, for example, a CMOS inverter.

Therefore, a technology is suggested in which the MEMS switch is used for a technique referred to as “power gating” (e.g., see A. Raychowdhury, Jeong I l Kim, D. Peroulis, K. Roy, “Integrated MEMS switches for Leakage Control of Battery Operated Systems”, Porc. IEEE 2006 Custom Integrated Circuits Conference (CICC), pp. 457 to 460). Power gating is a technology for reducing the power consumption of an IC. In this technology, the supply of a power voltage to an unused circuit block is blocked by a switch (hereinafter referred to as a power gating switch) to suppress the power consumption due to leakage.

The MEMS switch is provided as such a power gating switch between the circuit block and a power supply to decrease the power consumption.

In the literature of Raychowdhury et al., a thermal driving type MEMS switch is used as a power gating switch. The thermal driving type MEMS switch has an advantage that the switch operates at a low voltage. On the other hand, the thermal driving type MEMS switch uses a large driving current, and eventually the power consumption increases. Furthermore, the thermal driving type MEMS switch has a large size and a low switching speed as compared with a MEMS switch of another driving type.

Moreover, based on the fact that the MEMS switch should be interposed between the circuit block and the outside (or the power supply, a pad), it is expected that the MEMS switch is used in an electrostatic discharge (ESD) protection element. In this case however, the same problems as in the power gating technology may arise.

### SUMMARY

A switch according to an aspect of the present invention comprising: first and second electrodes provided on a substrate; an anchor provided on the first electrode; a movable structure of which a first end is supported by the anchor, extending from the anchor to a position above the second electrode, using a conductor, and configured to move in a vertical direction with respect to the second electrode; a contact portion provided at a second end of the movable structure and disposed above the second electrode; a film having a different stress value with respect to the stress value of the movable structure, and warping the contact portion toward the second electrode; and a cap provided on the substrate to cover the movable structure, configured to be in contact with the film, and functioning as a driving electrode.

A switch according to an aspect of the present invention comprising: first and second electrodes provided on a substrate; a third electrode provided on the substrate and between the first electrode and the second electrode; an anchor provided on the first electrode; a movable structure of which a first end is supported by the anchor, extending from the anchor to a position above the second electrode, using a conductor, and configured to move in a vertical direction with respect to the second electrode; a contact portion provided at a second end of the movable structure and disposed above the second electrode; a first film provided on the upper surface of the movable structure, the first film having a different stress value with respect to the stress value of the movable structure, and warping the contact portion toward the second electrode; a second film provided on the bottom surface of the movable structure, the second film having a different stress value with respect to the stress value of the movable structure, warping the movable structure toward the third electrode and configured to be in contact with the third electrode; and a cap provided on the substrate to cover the movable structure and being into contact with the first film.

An ESD protection element according to an aspect of the present invention comprising: a first terminal provided on a substrate of an IC chip and connected to a first interconnection which is connected to a device to be protected; and a switch provided on the substrate between the first terminal and a second interconnection and including a movable structure, wherein when the IC chip is non-active, the switch has a low impedance state, and when the IC chip is active, the switch has a high impedance state.

### BRIEF DESCRIPTION OF THE DRAWING

FIG. 1A is a plan view showing a structure of an MEMS switch;

FIG. 1B is a sectional view cut along the line A-A′ of FIG. 1A;

FIG. 10 is a sectional view cut along the line B-B′ of FIG. 1A;

FIGS. 2A to 2D are sectional views showing the manufacturing steps of the MEMS switch;

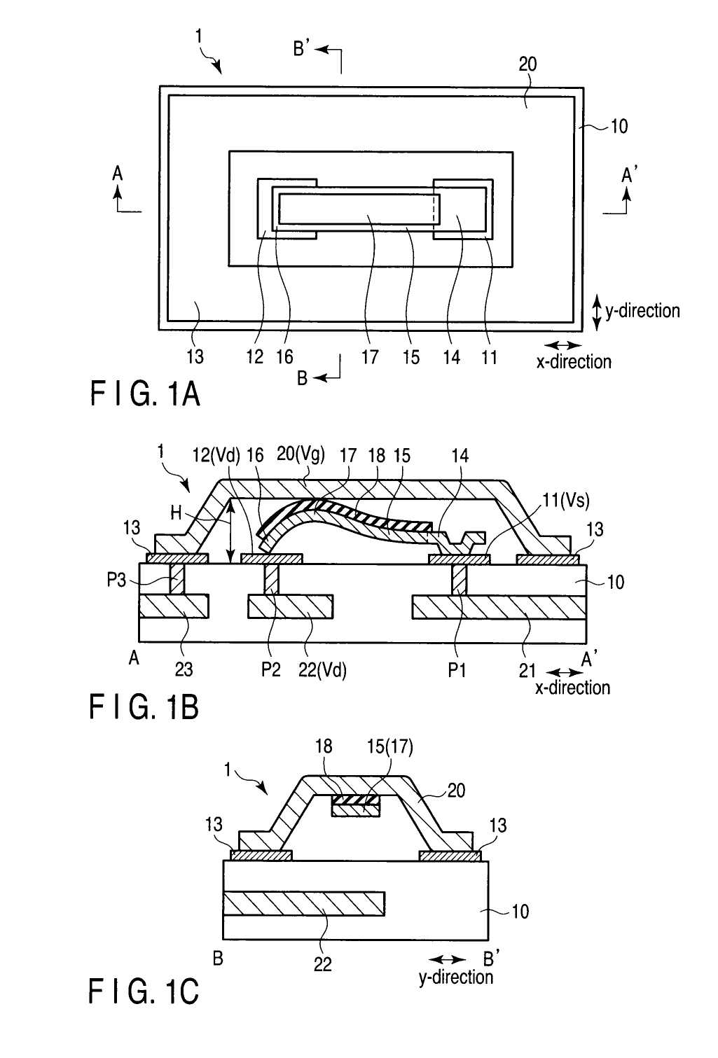

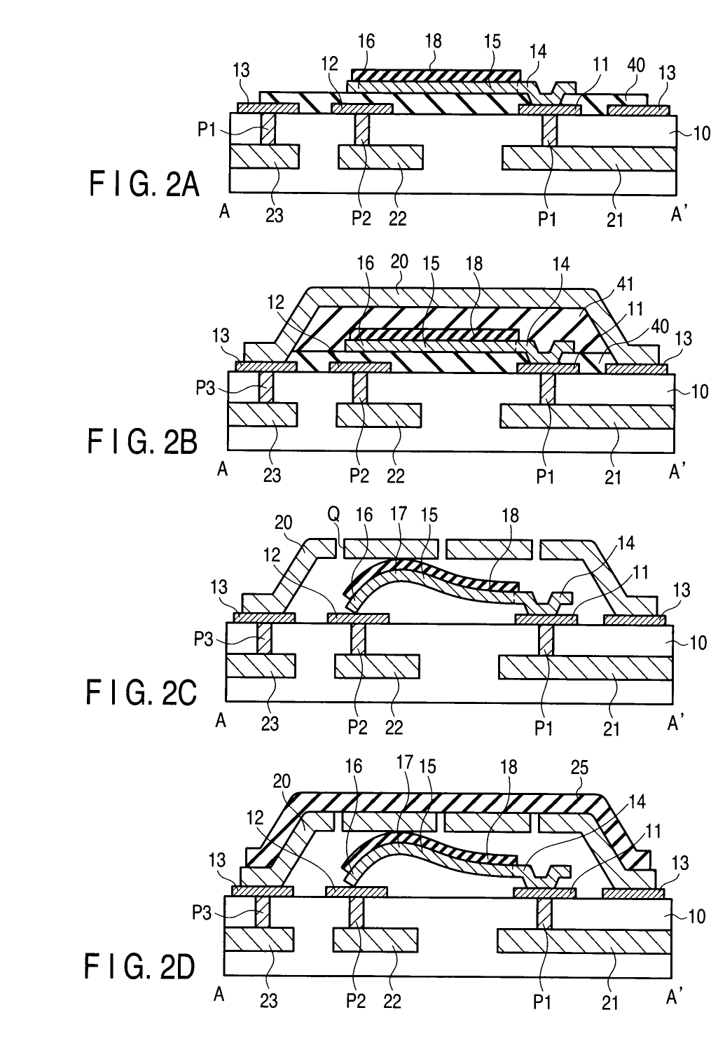

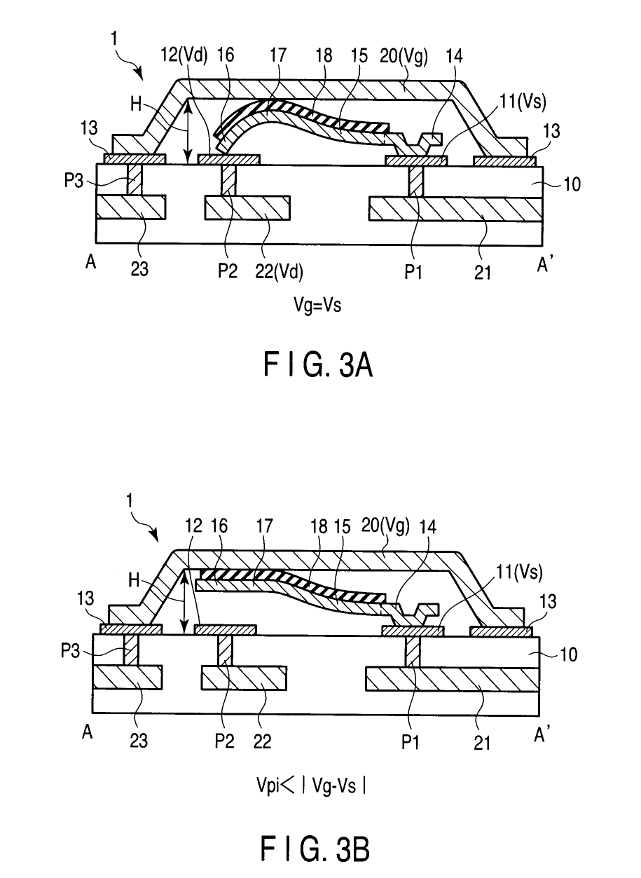

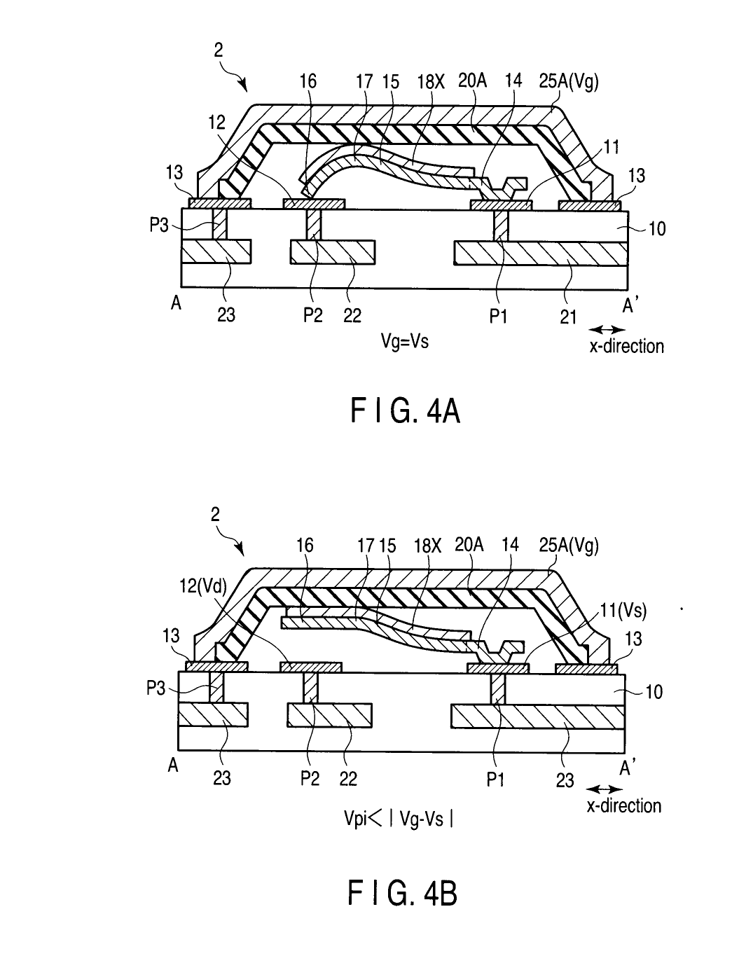

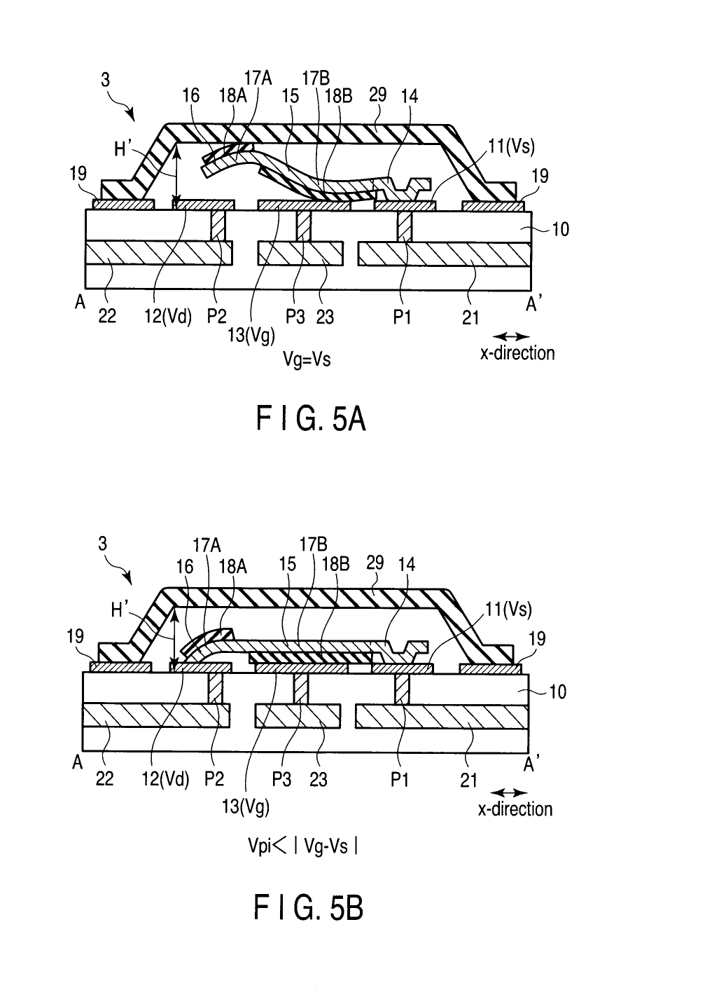

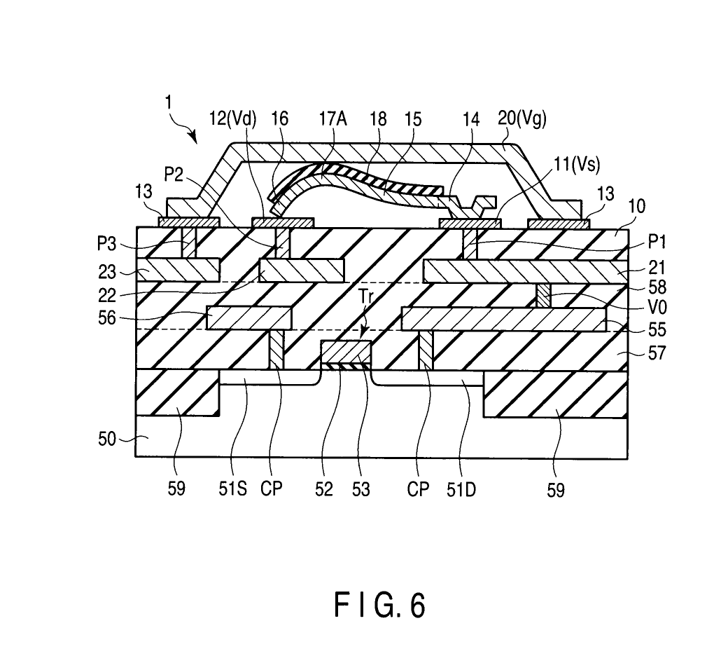

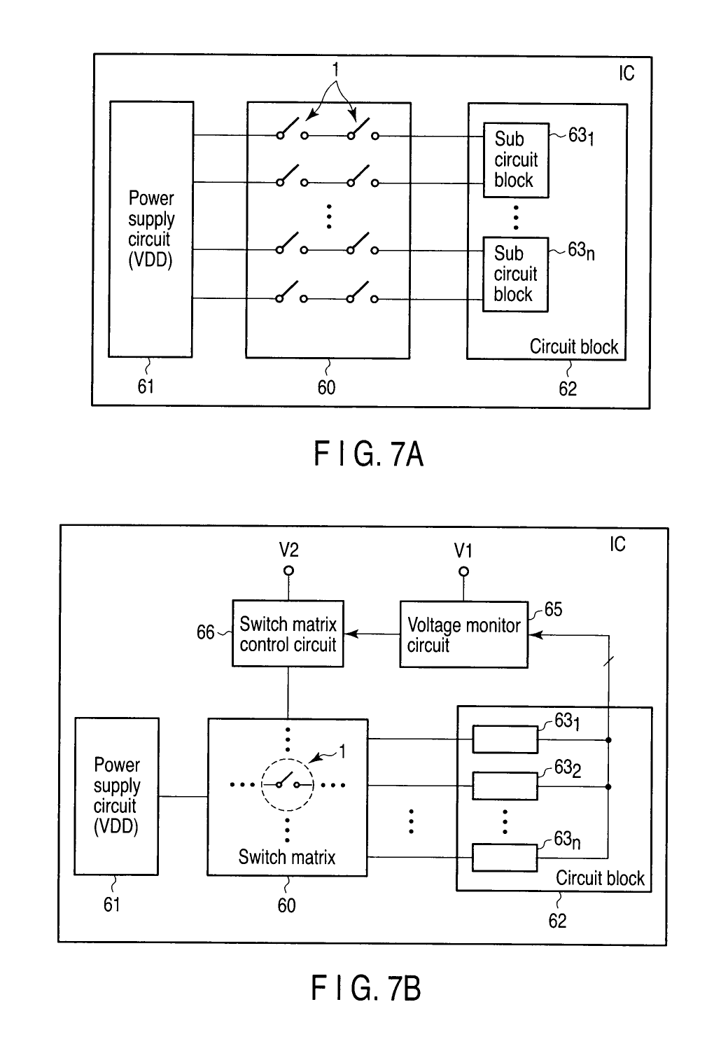

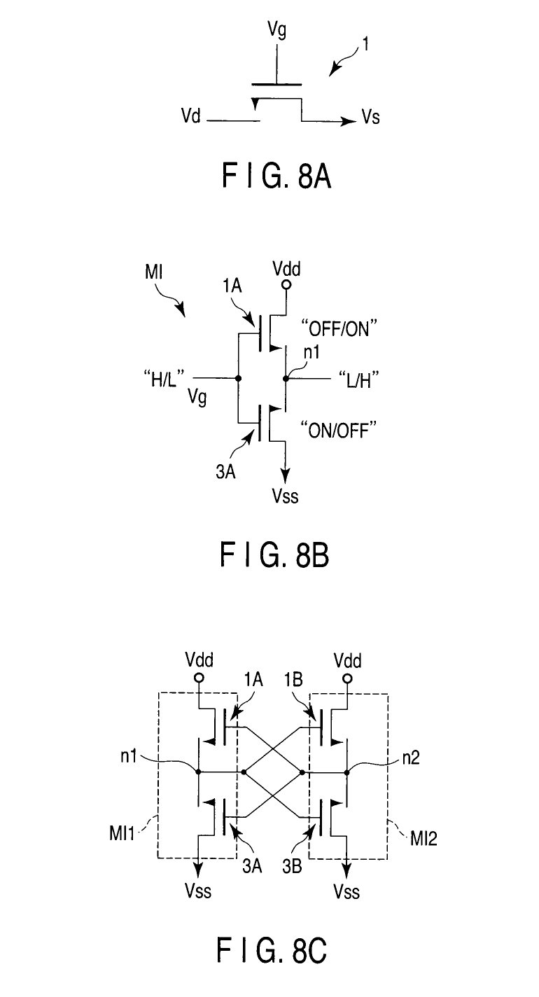

FIGS. 3A and 3B are diagrams for explaining the operation of the MEMS switch of FIG. 1;

FIGS. 4A, 4B, 5A and 5B are diagrams for explaining the structure and operation of the MEMS switch;

FIGS. 6, 7A, 7B, 8A, 8B and 8C are diagrams for explaining an application example of the MEMS switch;

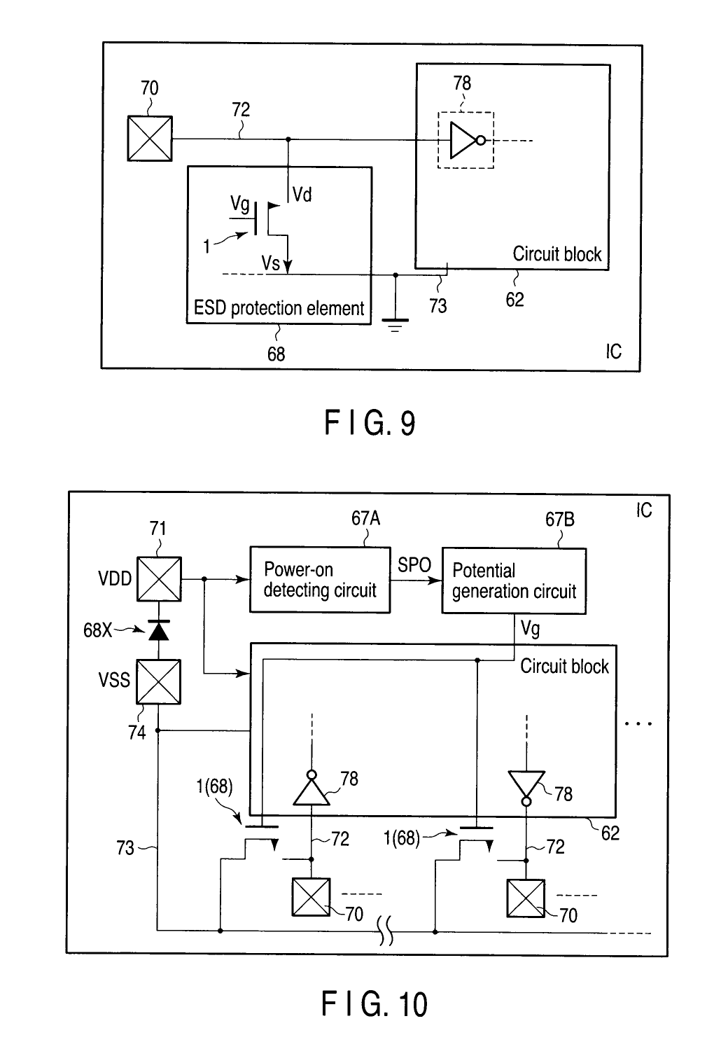

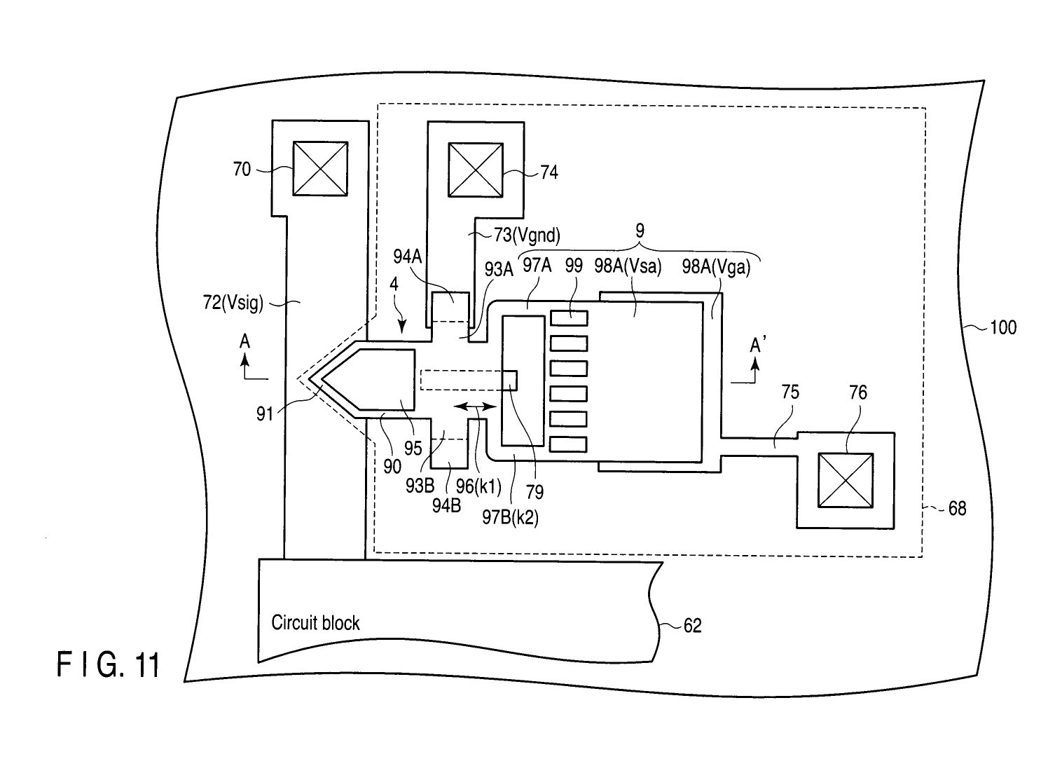

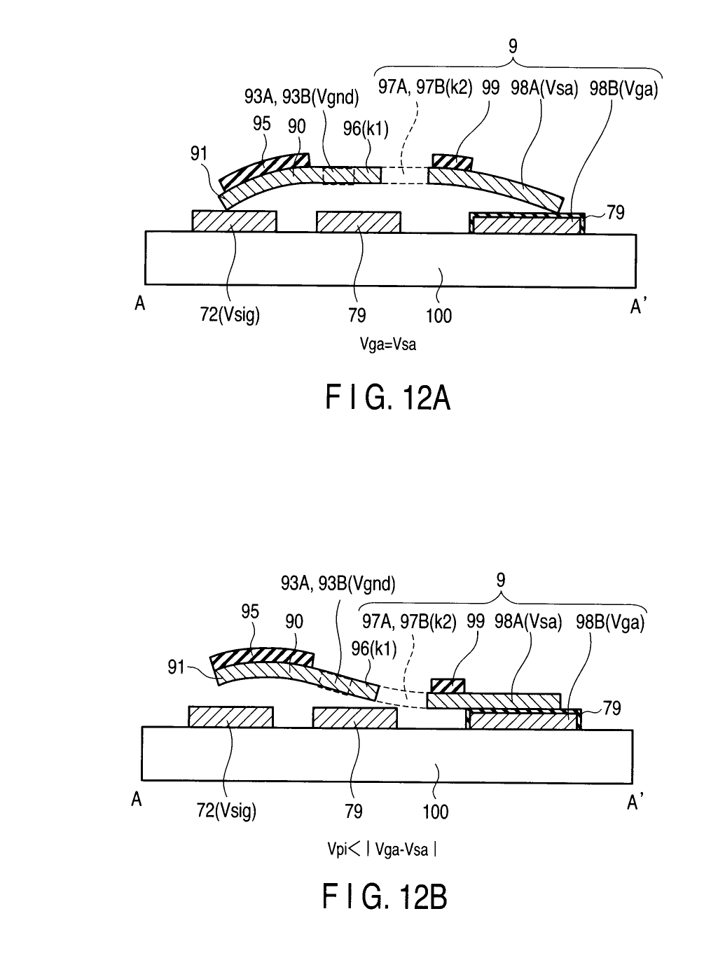

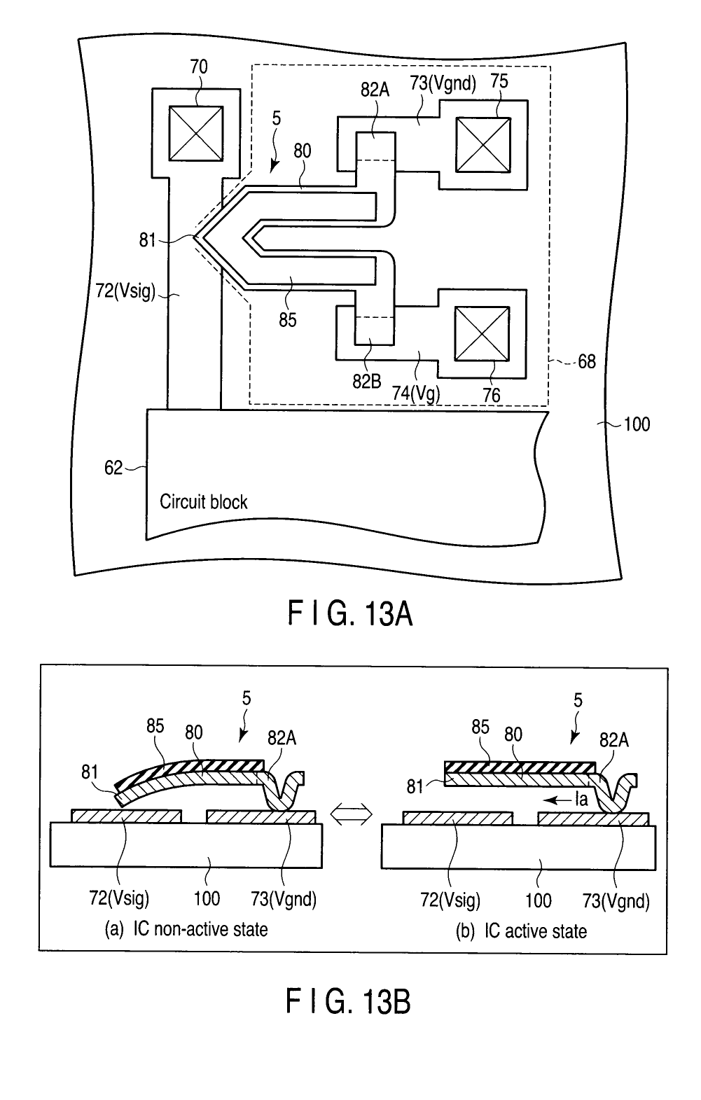

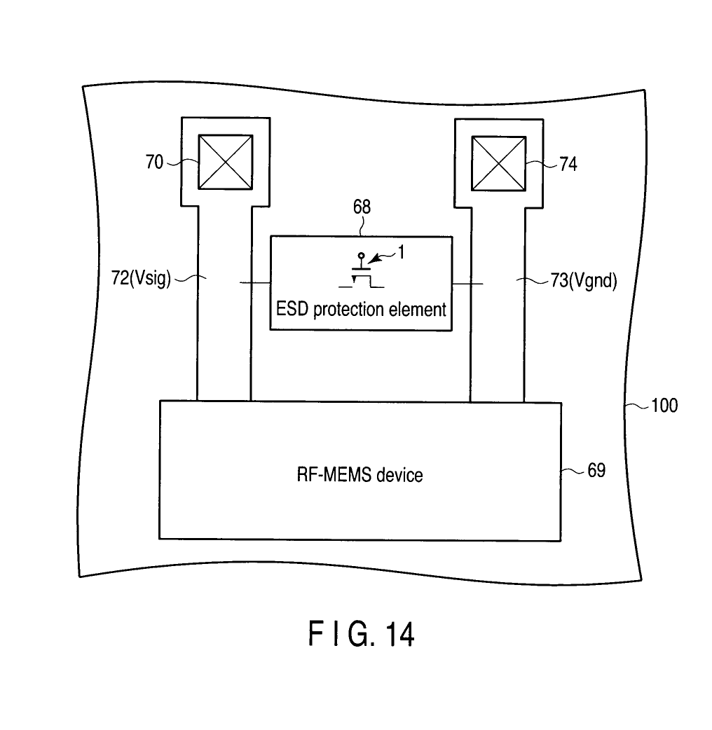

FIGS. 9 and 10 are diagrams for explaining a constitution example of the ESD protection element;

FIG. 11 is a diagram for explaining the structure of the ESD protection element;

FIGS. 12A, 12B, 13A and 13B are diagrams for explaining the structure and operation of the ESD protection element; and

FIG. 14 is a diagram for explaining a constitution example of the ESD protection element.

### DETAILED DESCRIPTION OF THE INVENTION

Hereinafter, embodiments of the present invention will be described in detail with reference to the drawings. It is to be noted that in the following description, components having the same functions and constitutions are denoted with the same reference numerals, and the detailed description thereof will be given where required.

### First Embodiment

In a first embodiment, a fine switch to which an MEMS is applied (hereinafter referred to as the MEMS switch) will be described.

### (1) Example 1

### (a) Structure

The structure of an MEMS switch according to one example of the first embodiment will be described with reference to FIGS. 1A, 1B and 10.

FIG. 1A is a plan view showing the structure of an MEMS switch 1 according to the first example of the present embodiment. FIG. 1B is a sectional view of the MEMS switch 1 along the line A-A′ of FIG. 1A. Moreover, FIG. 10 is a sectional view of the MEMS switch 1 along the line B-B′ of FIG. 1A.

The MEMS switch 1 shown in FIGS. 1A to 10 is a normally-on type MEMS switch. The driving system of this switch 1 is an electrostatic driving system.

An insulating substrate 10 is made of an insulating layer formed on a silicon substrate or a glass substrate.

The substrate 10 is provided with three electrodes 11, 12 and 13. Two electrodes 11, 12 are arranged in an x-direction (a first direction) side by side, and the one remaining electrode 13 is disposed so as to surround the peripheries of the two electrodes 11, 12 in the x-direction and y-direction (a second direction). The three electrodes 11, 12 and 13 are electrically separated from one another.

The electrodes 11, 12 and 13 are connected to interconnections 21, 22 and 23 in the substrate 10 via, for example, plugs P1, P2 and P3.

The first electrode (the first port) 11 is one electrode of the switch 1, and a potential Vs is supplied to the electrode 11. The electrode 11 is connected to the first interconnection 21 via, for example, the plug P1.

The second electrode (the second port) 12 is the other electrode of the switch 1, and a potential Vd is supplied to the electrode 12. The electrode 12 is connected to the second interconnection 22 via, for example, the plug P2.

Moreover, a potential Vg for driving the switch is supplied to the third electrode 13. The electrode 13 is connected to the third interconnection 23 via, for example, the plug P3.

A movable structure 15 is provided above the electrodes 11, 12. The movable structure 15 extends in a direction (the x-direction) in which the two electrodes 11, 12 are arranged side by side. The planar shape of the movable structure is, for example, rectangular.

One end of the movable structure 15 in the x-direction thereof is supported by an anchor 14 provided on the electrode 11, and the movable structure 15 has a cantilever structure (cantilever beam structure). Moreover, the sectional shape of the movable structure 15 along the x-direction is an upwardly convex shape.

The movable structure 15 moves in a vertical direction, that is, from an electrode 12 side to a cap 20 side, or from the cap 20 side to the electrode 12 side.

The movable structure 15 and the anchor 14 are made of, for example, conductors. The anchor 14 is electrically connected to the electrode 11. Therefore, the movable structure 15 is electrically connected to the electrode 11. The potential Vs is supplied from the electrode 11 to the movable 15.

The other end of the movable structure 15 in the x-direction is provided with a contact portion 16. The contact portion 16 is provided above the electrode 12. The contact portion 16 warps downwards, that is, toward the electrode 12. The contact portion 16 is brought into a contact state or a non-contact state with respect to the electrode 12 in accordance with the operation of the movable structure 15. The contact portion 16 is made of, for example, the same conductor as that of the movable structure.

On the movable structure 15, a regulation film 18 is provided, and the movable structure 15 and the regulation film 18 form a laminated structure. The regulation film 18 covers, for example, the upper side of the contact portion 16.

The internal stress of the regulation film 18 has relatively strong compressive properties as compared with that of the movable structure 15. Due to the compressive internal stress (hereinafter referred to as the compressive force) of the regulation film 18, the movable structure 15 has an upwardly convex shape on a contact portion 16 side, and the contact portion 16 is directed downwards (on a substrate side). Hereinafter, the upwardly convex portion of the movable structure 15 that is formed due to the internal stress of the regulation film 18 will be referred to as a convex portion 17.

As a material for the regulation film 18, for example, an insulator is used. However, any material may be used as the regulation film 18 as long as it has a compressive force larger than that of the movable structure 15.

The cap 20 is provided on the electrode 13 so as to cover the movable structure 15. A region between the movable structure 15 and the cap 20 is hollow, for example, a vacuum. Note that in FIGS. 1B and 10, the cap 20 having a single layer structure is shown for simplicity of description, but the cap may have a multilayered structure.

The cap 20 is in contact with a part of the regulation film 18. The cap 20 presses the convex portion 17 of the movable structure 15 from the upper side via the regulation film 18 to bring the contact portion 16 into contact with the electrode 12. In consequence, the force at the time of contact between the contact portion 16 and the electrode 12 (the contact force) is increased. The cap 20 includes a conductor, and is electrically connected to the electrode 13. The potential Vg is supplied from the electrode 13 to the cap 20.

In a case where the material of the regulation film 18 is an insulating film, a conductor is used as the material of the cap 20 which directly is in contact with the regulation film 18.

This cap 20 functions as a substantial electrode (the driving electrode) for driving the movable structure 15. That is, the on/off state of the MEMS switch 1 of the present example is controlled by a relation between the potential Vg supplied to the cap 20 and the potential Vs supplied to the movable structure 15.

For example, the MEMS switch 1 sets a potential difference between the potentials Vg and Vs to 0 V, whereby the top portion (the convex portion 17) of the movable structure 15 is pressed from the upper side to the substrate 10 side by the cap 20 to maintain the contact state between the contact portion 16 and the electrode 12.

Moreover, the MEMS switch 1 sets the potential difference between the potentials Vg and Vs to a certain potential difference or more to generate an electrostatic attraction between the movable structure 15 and the cap 20, thereby moving the movable structure 15. In consequence, the non-contact state between the contact portion 16 and the electrode 12 is maintained.

A space H between the bottom surface of the upper portion of the cap 20 and the surface of the substrate 10 enables that the contact state between the contact portion 16 and the electrode 12 to be maintained by the cap 20 when the potential difference between the movable structure 15 and the cap 20 is substantially 0 V, and also enables the contact portion 16 and the electrode 12 to be brought into a non-contact state when the potential difference between the movable structure 15 and the cap 20 becomes larger than a predetermined pull-in voltage Vpi at which the movable structure 15 starts to move. The upper limit value of the space H is more preferably 0.5 μm or less.

Note that since the regulation film 18 using the insulator is interposed between the movable structure 15 using the conductor and the cap 20 using the conductor, the movable structure 15 is not in electrical contact (short-circuit) with the cap 20.

The MEMS switch 1 shown in FIGS. 1A to 10 can realize the operation of the movable structure 15, that is, the control of the on/off state of the MEMS switch by controlling the potential difference between the movable structure 15 and the cap 20. When the switch 1 is turned on, the cap 20 presses the movable structure 15 from the upper side to electrode 12, and hence the potential difference between the movable structure 15 and the cap 20 is not necessary. Moreover, when the switch 1 is turned off, the movable structure 15 is driven by the electrostatic attraction caused by the potential difference between the movable structure 15 and the cap 20. Therefore, the power consumption of the MEMS switch 1 of the present example is small.

Furthermore, according to the above constitution, an actuator for operating the MEMS switch 1 does not have to be separately provided. Therefore, the MEMS switch described in the present example can decrease the area occupied by the MEMS switch.

Note that as to the MEMS switch 1 of the present embodiment, the constitution of the switch 1 shown in FIGS. 1A to 10 shows a basic constitution for realizing the present embodiment, and the present invention is not limited to this constitution. For example, in FIG. 1A, the planar shape of the movable structure 15 is rectangular, but the planar shape may be a convex on the contact portion 16 side. Moreover, the same material may be used in the movable structure 15 and the contact portion 16, and different materials may be used to decrease a contact resistance between the contact portion 16 and the electrode 12 or optimize the operation of the movable structure 15 or the like.

### (b) Manufacturing Method

The manufacturing method of the MEMS switch 1 of the present example will be described with reference to FIGS. 2A to 2D. FIGS. 2A to 2D are sectional views showing the manufacturing steps of the MEMS switch 1, respectively.

As shown in FIG. 2A, the interconnections 21, 22 and 23 and the plugs P1, P2 and P3 are formed in the predetermined positions of the substrate 10. Then, a conductive layer is deposited on the substrate 10, and this conductive layer is patterned into a predetermined shape. In consequence, the electrodes 11, 12 and 13 are formed on the substrate 10. The electrodes 11, 12 and 13 are formed so as to come in contact with the plugs P1, P2 and P3, respectively.

Next, a first sacrificial layer 40 is deposited on the substrate 10 and the electrodes 11, 12 and 13, and the upper surface of this sacrificial layer 40 is flattened. Then, a conductive layer, which becomes the movable structure 15 is deposited on the sacrificial layer 40, and the conductive layer is patterned into a predetermined shape.

Afterward, the sacrificial layer on the electrode 11 is removed to expose the surface of the electrode 11. Then, the anchor 14 for supporting the movable structure 15 is formed on the exposed electrode 11. The material of the anchor 14 is a conductor. Note that the anchor 14 may simultaneously be formed by using the same material as that of the movable structure 15.

The regulation film 18 having a predetermined shape is formed on the movable structure 15. The regulation film 18 covers the contact portion 16 from the upper side thereof. The material of the regulation film 18 is, for example, an insulator.

In these steps, the movable structure 15 is closely attached to the sacrificial layer 40. Therefore, even when the regulation film 18 is formed on the upper surface of the movable structure 15 and the compressive internal stress caused by the regulation film 18 is applied to the movable structure 15, the movable structure 15 maintains a substantially horizontal state with respect to the surface of the substrate 10.

As shown in FIG. 2B, a second sacrificial layer 41 is formed on the movable structure 15 and the regulation film 18. The upper surface of the sacrificial layer 41 is flattened so that the height of the upper surface of the sacrificial layer 41 from the surface of the substrate 10 is a predetermined height. Furthermore, the sacrificial layer 40 and 41 is patterned into a predetermined shape to expose the upper surface of the electrode 13.

Moreover, on the electrode 13 and the sacrificial layer 41, a conductive layer which becomes the cap 20 is deposited.

As shown in FIG. 2C, an opening Q is formed in the cap 20. Then, the sacrificial layer is removed through this opening Q by, for example, wet etching.

Since the sacrificial layer closely attached to the movable structure 15 is removed, the movable structure 15 curves owing to the difference in stress between the movable structure and the regulation film 18. Thus, the movable structure 15 has the convex portion 17 having an upwardly convex shape, and the contact portion 16 warps toward the electrode 12.

Moreover, the cap 20 presses the convex portion 17 from the upper side to the substrate 10 side via the regulation film 18. In consequence, the contact portion 16 is in contact with the electrode 12. This is realized by flattening the upper surface of the sacrificial layer 41 so that the height of the upper surface of the sacrificial layer (the film thickness of the sacrificial layer 41) is a predetermined height (the film thickness) to regulate the height of the cap 20 as in the step shown in FIG. 2C.

Then, to vacuum-seal the cavity between the cap 20 and the movable structure 15, a seal layer 25 is formed on the cap 20 as shown in, for example, FIG. 2D.

As described above, the MEMS switch according to the present example can be formed by a simple manufacturing method.

### (c) Operation

The operation of the MEMS switch 1 of the present example will be described with reference to FIGS. 3A and 3B. FIGS. 3A and 3B are diagrams for explaining the operation of the MEMS switch.

FIG. 3A shows the state of the MEMS switch 1 when the potential Vs supplied to the movable structure 15 and the potential Vg supplied to the cap 20 are substantially equal.

The potential Vs is supplied to the movable structure 15 via the electrode 11. The potential Vg is supplied to the cap 20 via the electrode 13. A potential difference (|Vg−Vs|) between the potentials Vs and Vg is substantially set to 0 V.

In the MEMS switch 1 of the present example, the convex portion 17 of the movable structure 15 is pressed from the upper side to the substrate 10 side by the cap 20 via the regulation film 18.

When the potential difference (|Vg−Vs|) is 0 V, no electrostatic attraction is generated between the movable structure 15 (the regulation film 18) and the cap 20, and the movable structure 15 is not attracted to the cap 20 as a driving electrode. Therefore, the movable structure 15 has an upwardly convex shape, and the contact portion 16 comes into contact with the electrode 12. Therefore, the electrodes 11 and 12 corresponding to ports of the MEMS switch 1 conduct. Thus, the state of the MEMS switch 1 before driving the movable structure 15 is an on-state. This on-state is held until the potential difference (|Vg−Vs|) between the movable structure 15 and the cap 20 becomes larger than the pull-in voltage Vpi.

Moreover, FIG. 3B shows the state of the MEMS switch 1 when the potential difference between the potentials Vg and Vs is larger than a predetermined potential difference.

The potential Vs is supplied to the movable structure 15, and the potential Vg having a size different from that of the potential Vs is supplied to the cap 20. In this case, an electrostatic attraction is generated between the movable structure 15 and the cap 20 as the driving electrode.

In a case where the potential difference (|Vg−Vs|) between the potential Vs of the movable structure 15 and the potential Vg of the cap 20 is set to a value larger than the pull-in voltage Vpi at which the movable structure 15 starts to move, the contact portion 16 is attracted to the cap 20 side (the upper side). In consequence, a portion of the movable structure 15 from the convex portion 17 to the contact portion 16 moves upwards (to the cap 20 side), and is in contact with the cap 20 via the regulation film 18. In consequence, the contact portion 16 and the electrode 12 are brought into a non-contact state, and are electrically separated from each other. That is, the electrodes 11 and 12 corresponding to the ports of the MEMS switch 1 do not conduct. Thus, the state of the MEMS switch 1 after driving the movable structure 15 is an off-state.

In the MEMS switch 1 of the present example, the convex portion 17 of the movable structure 15 constantly is in contact with the cap 20 via the regulation film 18. Therefore, when the movable structure 15 is driven and the MEMS switch 1 changes from the on-state to the off-state, a portion of the movable structure 15 from the convex portion 17 to the tip thereof successively is in contact with the cap 20 via the regulation film 18 in a zipper-like state. Such a zipper-like operation of the movable structure 15 means that the MEMS switch 1 can be driven at a low voltage.

In particular, when a space between the bottom surface of the upper portion of the cap 20 and the surface of the substrate 10 is set to 0.5 vim or less, the pull-in voltage Vpi which is the driving potential of the MEMS switch 1 can be decreased to 1 V or less. Therefore, the MEMS switch 1 of the present example can be driven at a low voltage.

As described above, the MEMS switch 1 described in Example 1 of the present embodiment presses the fine movable structure 15 (the convex portion 17) from the upper side to the substrate 10 side by use of the cap 20, and mechanically (structurally) brings the contact portion 16 into contact with the electrode 12, to hold the on-state. Moreover, the MEMS switch 1 of the present example electrically separates the contact portion 16 from the electrode 12 by electrostatic attraction, to hold the off-state.

In consequence, to hold the on/off state, the MEMS switch 1 of the present embodiment does not require a large power (voltage). Moreover, when the MEMS switch 1 is changed from the on-state to the off-state, the movable structure 15 is driven in a zipper-like operation by electrostatic attraction, and hence the driving voltage of the switch is small.

Therefore, according to the MEMS switch 1 of the present example, the power consumption of the MEMS switch 1 can be decreased.

In the MEMS switch 1 of the present example, the movable structure 15 is driven by the electrostatic attraction generated between the movable structure 15 and the cap 20. Therefore, it is not necessary to separately provide an actuator for driving the movable structure 15. Therefore, the occupying area of the MEMS switch can be decreased.

Moreover, the MEMS switch 1 of the present example is a normally-on type MEMS switch, and hence when the contact portion 16 and the electrode 12 are brought into a non-contact state even slightly, the switch immediately enters the off-state. That is, the MEMS switch 1 of the present example has a high switching speed. Furthermore, to realize the high-speed switching characteristics of the MEMS switch 1, the inside of the cap 20 is preferably brought into a vacuum state. When a common MEMS switch is sealed in the vacuum state, ringing occurs. On the other hand, in the MEMS switch 1 of the present example, since the top portion (the convex portion 17) of the movable structure 15 is constantly fixed to the cap 20, there is only a slight ringing effect. Therefore, the MEMS switch 1 of the present example can realize high-speed switching.

In addition, the level of electrostatic attraction between two conductors indicates dependence on the permittivity of the insulator interposed between the two conductors. Therefore, when a material having a large permittivity is used in the regulation film 18 as the insulator, the electrostatic attraction generated between the cap 20 and the movable structure 15 can be increased. When the material of the regulation film 18 is optimized in this manner, it is possible to contribute to an increase in the switching speed and a decrease in the power consumption.

As described above, according to Example 1 of the present embodiment, the power consumption of the MEMS switch can be decreased. Moreover, a small-sized MEMS switch can be provided. Furthermore, the switching characteristics of the MEMS switch can be improved.

### (2) Example 2

An MEMS switch 2 according to one example of the first embodiment will be described with reference to FIGS. 4A and 4B.

FIGS. 4A and 4B are diagrams for explaining the constitution and operation of the MEMS switch according to Example 2 of the present embodiment. Note that the planar shape of the MEMS switch 2 of the present example is substantially the same as that of the structure shown in FIG. 1A.

The MEMS switch 2 shown in FIGS. 4A and 4B is a normally-on type MEMS switch, and the driving system of the switch is an electrostatic driving system similar to that as in the MEMS switch 1 described in Example 1.

As described above, there is no particular restriction on the material of the regulation film for obtaining the upwardly convex shape of the movable structure as long as the internal stress of the regulation film has relatively strong compressibility with respect to the internal stress of the movable structure. Therefore, as shown in FIGS. 4A and 4B, a conductor may be used as the material of a regulation film 18X.

In this case, a cap (the lower-layer cap) 20A using an insulator is provided between the regulation film 18X using the conductor and a cap (the upper-layer cap) 25A as a driving electrode.

The cap 20A using the insulator is in direct contact with the regulation film 18X using the conductor. The cap 25A using the conductor is electrically connected to the electrode 13, and a potential Vg is supplied to the cap 25A via an electrode 13.

The operation of the MEMS switch 2 of the present example is substantially the same as that of the MEMS switch 1 shown in FIGS. 1A to 10.

FIG. 4A shows the state of the MEMS switch 2 when the potential Vg is substantially equal to a potential Vs.

When a potential difference between the potential Vs of a movable structure 15 and the potential Vg of the cap 25A is substantially 0 V, no electrostatic attraction is generated between the cap 20A or 25A and the movable structure 15. Therefore, when a convex portion 17 of the movable structure 15 is pressed from the upper side to the electrode 12 side by the caps 20A, 25A, a contact portion 16 is in contact with an electrode 12, and the two electrodes 11, 12 conduct. Therefore, the MEMS switch 2 before driving the movable structure 15 is an on-state.

Moreover, FIG. 4B shows the state of the MEMS switch 2 when a potential difference between the potentials Vg and Vs is larger than a certain potential difference.

When the potential difference between the potentials Vs and Vg is larger than a pull-in voltage Vpi, a portion of the movable structure 15 between the convex portion 17 and a tip is attracted to a cap 25A side in a zipper-like manner due to the electrostatic attraction generated between the cap 25A and the movable structure 15. In consequence, the contact portion 16 and the electrode 12 are brought into a non-contact state, and the two electrodes 11 and 12 corresponding to ports of the MEMS switch 2 do not conduct. Therefore, the MEMS switch 2 after driving the movable structure 15 is an off-state.

As described above, as the material of constituent members of the MEMS switch 2 shown in FIGS. 4A and 4B, a material different from that of the constituent members of the MEMS switch 1 shown in FIGS. 1A to 1C is used. Also in this case, the MEMS switch 2 shown in FIGS. 4A and 4B is driven by a small driving voltage and holds the on/off state with a low power consumption in the same manner as in the MEMS switch 1 shown in FIGS. 1A to 1C.

Therefore, needless to say, an effect similar to that of the MEMS switch shown in FIGS. 1A to 1C is also obtained in the MEMS switch 2 shown in FIGS. 4A and 4B.

Note that the MEMS switch 2 of the present embodiment is different from the MEMS switch 1 shown in FIGS. 1A to 1C only in a material used in each constituent element, and the manufacturing method of the MEMS switch is substantially the same as the manufacturing steps described with reference to FIGS. 2A to 2D.

### (3) Example 3

### (a) Structure

An MEMS switch 3 according to one example of the first embodiment will be described with reference to FIGS. 5A and 5B.

FIGS. 5A and 5B are diagrams for explaining the constitution and operation of the MEMS switch according to Example 3 of the present embodiment. Note that the planar shape of the MEMS switch 3 of the present example has the same structure as that shown in FIG. 1A.

In Examples 1 and 2, the normally-on type MEMS switches 1, 2 have been described, but a normally-off type MEMS switch can be realized by using a regulation film laminated on a movable structure and a cap which is in contact with a portion (a convex portion) of the movable structure via the regulation film.

The MEMS switch 3 shown in FIGS. 5A and 5B is a normally-off type MEMS switch. The driving system of the MEMS switch 3 is an electrostatic driving system in the same manner as in the MEMS switches of Examples 1 and 2.

A movable structure 15 is supported by an anchor 14 provided on an electrode 11. A contact portion 16 is provided on the tip side of the movable structure 15. The contact portion 16 is disposed above an electrode 12. When the MEMS switch 3 has an on-state, the contact portion 16 is in contact with the electrode 12. When the MEMS switch 3 has an off-state, the contact portion 16 is not in contact with the electrode 12.

A cap 29 is provided on, for example, a dummy layer 19. The same material as that of the electrodes 11 and 12 and an electrode 13 is used in the dummy layer 19.

In the normally-off type MEMS switch 3 of the present example, the cap 29 does not function as a driving electrode. The driving electrode 13 of the MEMS switch 3 of the present example is provided on a substrate 10.

The driving electrode 13 is provided between the electrode (the first port) 11 connected to the anchor 14 and the electrode (the second port) 12 which is in contact with the contact portion 16, and is disposed together with electrodes 11, 12 in an x-direction.

Two regulation films 18A, 18B are provided on the movable structure 15. The first regulation film (first film) 18A is provided on the upper surface of the movable structure 15 to cover the contact portion 16 from the upper side. The second regulation film (second film) 18B is provided on the bottom surface of the movable structure 15, and is disposed between the regulation film 18A and the anchor 14 so as to be in contact with the driving electrode 13.

The regulation films 18A, 18B have an internal stress with relatively strong compressive properties with respect to the internal stress of the movable structure 15. Due to this stress, the movable structure 15 curves.

A portion 17A in the movable structure 15 provided with the regulation film 18A is deformed into an upwardly (the cap side) convex shape. In consequence, the contact portion 16 warps on a substrate side (the electrode 12 side). Thus, the contact portion 16 has a curved structure, whereby the contact portion 16 obtains a large contact force with respect to the electrode 12 during the contact with the electrode 12.

A portion 17B in the movable structure 15 provided with the regulation film 18B is deformed into a downwardly (the substrate side) convex shape. In consequence, the movable structure 15 warps upwardly (a cap 29 side), and a portion of the movable structure 15 provided with the regulation film 18B has a downwardly convex shape.

Hereinafter, the portion 17A of the movable structure 15 which is upwardly convex is referred to as the convex portion 17A, and the portion 17B of the movable structure 15 which is downwardly convex is referred to as the downwardly convex portion 17B.

The driving electrode 13 is disposed under the regulation film 18B. Moreover, the convex portion 17A is pressed from the upper side to the substrate 10 side by the cap 29 so that the driving electrode 13 is in direct contact with a part (the downwardly convex portion 17B) of the regulation film 18B. However, the regulation film 18B may be disposed slightly away from the driving electrode 13. Noted that a space H′ between the cap 29 and the surface of the substrate 10 prevents the contact portion 16 from coming into contact with the electrode 12 when a potential difference (|Vg−Vs|) between the electrode 11 and the driving electrode 13 is substantially 0 V.

Thus, in the MEMS switch 3 of the present example, the regulation film 18B which imparts a compressive internal stress to the movable structure 15 is provided on the bottom surface of the movable structure 15, and the portion 17B of the movable structure provided with the regulation film 18B warps upward. In consequence, according to the MEMS switch 3 of the present example, there is provided a normally-off type MEMS switch in which the contact portion 16 does not come into contact with the electrode 12 when a potential difference between the movable structure 15 and the driving electrode 13 is substantially 0 V, that is, in a state before driving the movable structure 15.

Note that the manufacturing method of the MEMS switch 3 shown in FIGS. 5A and 5B is different from that shown in FIGS. 2A to 2D in the following steps. On a sacrificial layer, the regulation film 18B for warping the movable structure 15 upwards is formed, and then a conductive film which becomes the movable structure 15 and the anchor 14 is formed on the regulation film 18B. Then, the regulation film 18A for warping the contact portion 16 of the movable structure 15 downwards is formed above the contact portion 16 in the movable structure. Afterward, the cap 29 is formed and the sacrificial layer is removed in the same manner as in the steps shown in FIGS. 2A to 2D. In consequence, the MEMS switch 3 shown in FIGS. 5A and 5B is completed.

### (b) Operation

The operation of the normally-off type MEMS switch 3 of the present example will be described with reference to FIGS. 5A and 5B.

FIG. 5A shows the state of the MEMS switch 3 when potentials Vg and Vs are substantially equal.

The potential Vs is supplied to the anchor 14 and the movable structure 15 via the electrode 11. The potential Vg is supplied to the driving electrode 13. The potential difference (|Vg−Vs|) between the potentials Vs and Vg is substantially set to 0 V.

In this case, since there is no potential difference between the driving electrode 13 and the movable structure 15, no electrostatic attraction is generated between the driving electrode 13 and the movable structure 15. Therefore, the movable structure 15 does not move, and the contact portion 16 is not in contact with the electrode 12. That is, the two electrodes 11, 12 corresponding to ports of the MEMS switch 3 do not conduct. Therefore, the state of the MEMS switch 3 before driving the movable structure 15 is an off-state.

FIG. 5B shows the state of the MEMS switch 3 when the potential difference between the potentials Vg and Vs is larger than a certain potential difference.

When the potential difference (|Vg−Vs|) between the potential Vg of the driving electrode 13 and the potential Vs of the movable structure 15 increases, electrostatic attraction is generated between the driving electrode 13 and the movable structure 15. Then, when the potential difference (|Vg−Vs|) is larger than a pull-in voltage Vpi, the movable structure 15 is attracted to the electrode 13 by electrostatic attraction, and moves downwards (a substrate 10 side). By the movement of the movable structure 15, the regulation film 18A comes away from the cap 29, and the contact portion 16 on the tip side of the movable structure 15 comes into direct contact with the electrode 12. In consequence, the two electrodes 11, 12 corresponding to the ports of the MEMS switch 3 conduct. Therefore, the state of the MEMS switch 3 after driving the movable structure 15 is an on-state.

When the MEMS switch 3 changes from the off-state to the on-state, a portion of the movable structure 15 on a contact portion 16 side from a contact portion between the regulation film 18B and the electrode 13 successively is in contact with the electrode 13 in a zipper-like manner. Thus, the movable structure 15 moves in a zipper-like manner, and hence the MEMS switch can be driven at a low voltage.

Moreover, as described above, the contact portion 16 has such a structure as to warp on the electrode 12 side and the whole bottom surface of the regulation film 18B directly is in contact with the driving electrode 13, whereby a large contact force is obtained between the contact portion 16 and the electrode 12.

As described above, also in the normally-off type MEMS switch of the present example, a power consumption can be decreased in the same manner as in the normally-on type MEMS switch described in Example 1.

### (4) Application Example

Hereinafter, application examples of the MEMS switches 1, 2 and 3 described in the present embodiment will be described with reference to FIGS. 6 to 8C.

(a) Power Gating Switch

The MEMS switches 1, 2 and 3 of the present embodiment can be applied to a power gating switch.

For example, as shown in FIG. 6, a semiconductor integrated circuit (hereinafter referred to as the IC) is formed on a semiconductor substrate (the chip) 50. Note that in FIG. 6, for simplicity of description, only one field effect transistor Tr is shown.

An element forming region of the semiconductor substrate 50 is defined by an isolation insulating film 59. The field effect transistor Tr is provided in the element forming region.

The field effect transistor Tr has two diffusion layers 51S, 51D as a source/drain in the semiconductor substrate 50. On the surface (the channel region) of the semiconductor substrate 50 between the two diffusion layers 51S and 51D, a gate insulating film 52 is provided. On the gate insulating film 52, a gate electrode 53 is provided. On the diffusion layers 51S, 51D, contact plugs CP are provided, and the diffusion layers 51S, 51D are connected to interconnections 55, 56 via the contact plugs CP.

To cover the field effect transistor Tr, interlayer insulating films 10, 57 and 58 are provided on the semiconductor substrate 50. A plurality of interconnections are laminated by a multi-level interconnection technology, and the plurality of interlayer insulating films 10, 57 and 58 are provided with a plurality of interconnections 21, 22, 23, 55 and 56, respectively.

An MEMS switch 1 is provided as the power gating switch above the semiconductor substrate 50. That is, the MEMS switch 1 as the power gating switch uses the top layer 10 of the interlayer insulating films as the substrate 10 provided with the MEMS switch. Then, the interconnections 21, 55 are electrically connected to the transistor Tr on the semiconductor substrate 50 via plugs P1, V0 and the plugs CP.

Thus, in the MEMS switch 1, the interlayer insulating films are used as the substrate and can be laminated on the semiconductor integrated circuit (IC), and hence the chip size of the IC chip does not increase owing to the use of the MEMS switch 1. Therefore, when the MEMS switch 1 of the present embodiment is used as the power gating switch, the chip size can be reduced as compared with the power gating switch (hereinafter referred to as the transistor switch) using the field effect transistor formed on the surface of the substrate as in, for example, a CMOS inverter.

Even when the transistor switch has an off-state, leakage is generated. Moreover, when the transistor switch is miniaturized to suppress an increase in the chip size due to the use of a power gating technology, leakage is generated owing to the short channel effect of the transistor or the like. Therefore, the transistor switch suffers from leakage and a power consumption due to such leakage, and hence cannot sufficiently perform the function as a power gating switch.

On the other hand, when the MEMS switch 1 has an off-state, there is substantially no leakage, whereby the switch 1 is very effective for decreasing the power consumption of the whole chip.

Furthermore, in a transistor switch, when there is no driving voltage (gate voltage), it is difficult to hold the on-state. In consequence, power has to be supplied to the power gating switch to reduce the power consumption in order to operate the transistor of the switch.

On the other hand, as in the MEMS switch 1 shown in FIGS. 1A to 10, in a case where the normally-on type MEMS switch 1 has a constitution such that the cap 20 presses the movable structure 15 from the upper side to mechanically bring the contact portion 16 into contact with the electrode 12 as the port, the power for holding the on-state is not necessary. Moreover, in the MEMS switch 1, since the movable structure 15 moves in a zipper-like manner due to electrostatic attraction, the power consumption (the driving voltage) required for obtaining the off-state is decreased. Furthermore, the normally-on type MEMS switch 1 immediately turns off when the contact portion 16 comes away from the electrode 12, thus the switching operation of the switch is fast.

Moreover, since the transistor switch has a diffusion layer in the semiconductor substrate 50, a parasitic capacity/parasitic resistance due to the diffusion layer is present, and the operation of the IC is delayed or adversely affected. On the other hand, the MEMS switch 1 is advantageous in that the on-resistance is small, parasitic capacity is small and no devices are distorted, and hence has only slight adverse influence on the IC.

Therefore, the MEMS switch of the present embodiment is very effectively used as a power gating switch.

A more specific application example of the power gating technology using the MEMS switch of the present embodiment will be described with reference to FIGS. 7A and 7B. FIGS. 7A and 7B are block diagrams for explaining an application example of power gating technology using a MEMS switch.

As shown in FIG. 7A, in the power gating technology, a switch matrix 60 constituted of a plurality of power gating switches is provided between a power supply circuit 61 in an IC chip and a circuit block 62 of the IC chip. Note that FIG. 7A shows only one circuit block, but needless to say, one IC chip may include a plurality of circuit blocks.

The power supply circuit 61 generates a power voltage VDD. The circuit block 62 is constituted of a plurality of sub-circuit blocks 63₁ to 63ₙ.

The MEMS switches 1 of the present embodiment are used in the power gating switches 1 constituting the switch matrix 60.

The power voltages VDD are supplied to the plurality of circuit blocks 63₁ to 63ₙ via the switch matrix 60, respectively.

In this case, the switch matrix 60 controls the on/off state of the MEMS switch 1 in the switch matrix 60 so that the power voltage VDD is not supplied to the non-operating circuit blocks 63₁ to 63ₙ.

As shown in FIG. 7A, the power supply circuit 61 is preferably connected to one of the sub-circuit blocks 63₁ to 63ₙ, respectively, by use of a constitution in which two or more MEMS switches 1 are connected in series. This is because even in a case where a defect such that the one MEMS switch 1 does not switch from the on-state to the off-state is generated owing to stiction, when the other switch connected in series to the defective switch is turned off, the supply of the power voltages to the sub-circuit blocks can be blocked.

Moreover, as shown in FIG. 7A, the power supply circuit 61 may be connected to one of the sub-circuit blocks 63₁ to 63ₙ by two current paths. Thus, the plurality of MEMS switches 1 connected to the respective sub-circuit blocks 63₁ to 63ₙ are arranged in parallel, whereby even in a case where the MEMS switch 1 which does not turn on is present in the one path connecting the power supply circuit 61 to the sub-circuit blocks 63₁ to 63ₙ, the normal on/off state of the MEMS switch 1 can be controlled to supply the power voltage VDD from the power supply circuit 61 to the predetermined sub-circuit blocks 63₁ to 63ₙ via the other path connected in parallel.

As shown in FIG. 7B, there may further be provided a voltage monitor circuit 65 which monitors the operation situations of the sub-circuit blocks 63₁ to 63ₙ in the circuit block 62 and a switch matrix control circuit 66 which controls the operation of the switch matrix 60.

In a constitution shown in FIG. 7B, the voltage monitor circuit 65 monitors a potential in the sub-circuit blocks 63₁ to 63ₙ in the circuit block 62, and feed the monitored voltage back to the switch matrix control circuit 66. According to such a constitution, the operation state of the respective circuit blocks 63₁ to 63ₙ and the presence/absence of the supply power are mutually reflected, whereby a defective switch in the switch matrix 60 can be identified. Then, the identified defective switch is considered to be non-selective, and may not be driven. Moreover, the defective switch may be replaced with a spare switch.

As described above, the MEMS switches 1, 2 and 3 of the present embodiment are used as power gating switches, which can contribute to a decrease in the chip size and can decrease the power consumption of the circuit block 62.

(b) Circuit

The MEMS switches 1, 2 and 3 of the present embodiment can be applied to a logical circuit or a storage circuit. FIGS. 8A, 8B and 8C show equivalent circuit diagrams of a circuit using the MEMS switch.

The MEMS switch can be shown by a circuit element shown in FIG. 8A. In FIG. 8A, a control terminal (the gate) to which a potential Vg is applied corresponds to the driving electrode of the MEMS switch. One end Vs and the other end Vd of a current path correspond to two ports of the MEMS switch.

The normally-on type MEMS switch turns on when the potential difference is a pull-in potential Vpi or less, and turns off when the potential difference is larger than the pull-in potential Vpi. When the potential not more than the pull-in potential Vpi is an “L” level and the potential larger than the pull-in potential Vpi is an “H” level, the normally-on type MEMS switch is equivalent to a P-channel MOS transistor using silicon.

On the other hand, the normally-off type MEMS switch turns off when the potential difference is the pull-in potential Vpi or less, and turns on when the potential difference is larger than the pull-in potential Vpi. That is, the normally-off type MEMS switch is equivalent to an N-channel transistor using silicon.

Therefore, by using the normally-on type MEMS switch 1 and the normally-off type MEMS switch 3 described in the present embodiment, a logical gate equivalent to a circuit using the MOS transistor can be constituted.

As shown in, for example, FIG. 8B, by using each of the normally-on/off type MEMS switches 1A, 3A, a CMOS inverter (the NOT gate) can be constituted.

In an inverter MI using the MEMS switch, control gates (the driving electrodes) are connected in parallel to form input node. Moreover, the ends (the second ports) of two MEMS switches constituting the inverter MI are connected in series to form output node n1.

Moreover, to the other end (the first port) of the normally-on type MEMS switch, a driving potential Vdd is supplied, and to the other end (the first port) of the normally-off type MEMS switch, a ground potential Vss is supplied.

The operation of the inverter MI using this MEMS switch is similar to that of the CMOS inverter. That is, one of signals of the “H” level (e.g., the potential Vdd) and the “L” level (e.g., a potential of 0 V) is input into the input node of the inverter MI. In accordance with the level of the signal, the one MEMS switch turns on, and the other MEMS switch turns off. The MEMS switch which has turned off becomes a load with respect to the MEMS switch which has been turned on. In consequence, the signal output from an output node n1 is the inverted signal of the input signal.

As described above, MEMS switches 1A, 3A have substantially no leakage. Therefore, the MEMS switches can be used to realize a leak-less logic having very small leakage.

Note that here an example has been described in which the MEMS switch is applied to an inverter (the NOT gate), but needless to say, the normally-on/off type MEMS switch can be used to constitute another circuit (a logical gate) such as an NAND gate or an NOR gate.

Moreover, as shown in FIG. 8C, MEMS switches can be used to constitute a storage circuit. In FIG. 8C, a static random access memory (SRAM) is constituted by using the MEMS switches.

The SRAM shown in FIG. 8C is constituted of two inverters MI shown in FIG. 8B, that is, four MEMS switches 1A, 1B, 3A and 3B.

The connection relationship between inverters MI1, MI2 and the respective MEMS switches 1A, 1B, 3A and 3B is similar to that in an SRAM constituted by flip-flop connecting CMOS inverters. That is, an input node of the one inverter MI1 is connected to an output node n2 of the other inverter MI2, and an input node of the other inverter MI2 is connected to an output node n1 of the one inverter MI1. Note that the nodes n1, n2 are connected to a word line and two bit lines via selective switches, respectively, but this is not shown in FIG. 8C.

The potentials of the word line and the bit lines are controlled to execute the writing and reading of data in and from the SRAM using the MEMS switches.

The SRAM using the MEMS switches can be used as a resistor for temporarily storing the calculated data of the sub-circuit blocks 63₁ to 63ₙ in the circuit block 62 shown in, for example, FIGS. 7A and 7B. As described above, since the MEMS switch has a small power consumption, the power consumption can be decreased in the register (SRAM) using the MEMS switches as compared with a register using the CMOS inverter. Moreover, since the MEMS switch can be laminated above the semiconductor substrate (the chip), the chip size can be decreased. Furthermore, since the MEMS switch hardly has any leakage, the retention characteristics of the data can be improved.

As described above, the normally-on/off type MEMS switch described in the present embodiment is used in the constituent element of the logical gate or the storage circuit, which can contribute to a decrease in the power consumption, decrease in the chip size, stabilization of data retention and the like.

### Second Embodiment

As described above, an MEMS structure and a switch (an MEMS switch) having the MEMS structure can be applied to various devices.

Besides the use shown in FIGS. 6 to 8C, it is expected that the MEMS switch (the MEMS structure) will be used as an element to protect various circuits and elements from ESD, that is, a so-called ESD protection element.

Hereinafter, an ESD protection element using the MEMS switch will be described.

### (1) Example 1

One example of an ESD protection element using an MEMS switch will be described with reference to FIG. 9. FIG. 9 is a block diagram showing a chip (IC) provided with an ESD protection element 68 using the MEMS switch.

The ESD protection element 68 shown in FIG. 9 uses, for example, a normally-on type MEMS switch 1 shown in FIG. 1. The ESD protection element 68 protects a circuit block (device) 62 to be protected from ESD. Hereinafter, circuit block 62 to be protected from ESD will be referred to as an ESD protection target circuit. Note that in FIG. 9, the one circuit block 62 is connected to the one ESD protection element 68, but needless to say, the one circuit block 62 may be connected to a plurality of ESD protection elements 68.

As shown in FIG. 9, one end of a current path of the circuit block 62, for example, an input/output portion 78 (e.g., the inverter) is connected to a pad (an input/output terminal) 70. Moreover, the other end of the current path of the circuit block 62 is connected to a ground line (a low potential power interconnection) 73. To a signal line 72, a signal potential corresponding to an input or output signal is supplied, and to the ground line 73, a ground potential is supplied. When the ESD is generated, an ESD pulse is applied from the pad 70 to the circuit block 62.

The ESD protection element 68 is connected in parallel with an ESD protection target circuit (the circuit block 62). That is, one terminal (a second port (Vd)) of an MEMS switch 1 as the ESD protection element 68 is electrically connected to the signal line 72 which connects the ESD protection target circuit (the circuit block 62) to the pad 70. The other terminal (a first port (Vs)) of the MEMS switch 1 is electrically connected to the same ground line 73 as in the other end of the ESD protection target circuit (the circuit block 62). Note that the ESD protection element 68 using the MEMS switch 1 and the ESD protection target circuit (the circuit block 62) may be connected to different ground lines.

When the normally-on type MEMS switch 1 shown in FIGS. 1A to 10 is used in the ESD protection element 68, for example, a terminal (the pad) drawn from the signal line 72 is connected to an electrode, the electrode is brought into contact/non-contact with the contact portion 16, and the movable structure 15 and the anchor 14 are connected to the ground line 73 common to the circuit block 62. Therefore, the ground line 73 corresponds to the one electrode (the first port) of the MEMS switch, and the signal line 72 corresponds to the other electrode (the second port) of the MEMS switch. Moreover, the cap 20 becomes a control terminal (the gate) which controls the operation of the MEMS switch 1 as the ESD protection element 68, and a driving potential Vg is supplied to the terminal.

The operation of the ESD protection element 68 using the MEMS switch 1 shown in FIGS. 1A to 10 is as follows. Note that the operation of the MEMS switch 1 has been described with reference to FIGS. 3A and 3B, and hence a detailed description thereof is omitted.

When the circuit block 62 is non-active, that is, no power voltage is supplied to the circuit block 62, the MEMS switch 1 as the ESD protection element 68 is turned on. Therefore, the pad 70 is connected to the ground line 73 via two ports of the MEMS switch 1. Note that an active state of a chip may be defined as a state in which a power voltage is supplied to the chip or a state in which a power voltage is supplied to the chip and a control signal for enabling the chip is input in the chip.

When the ESD pulse is input into the pad 70, the ESD pulse is applied to the MEMS switch 1 as the ESD protection element 68. That is, the ESD pulse is discharged from the contact portion 16 electrically connected to the signal line 72 to the ground line 73 via the movable structure 15 and the anchor 14.

Therefore, an excessively large breakdown voltage/current due to ESD is not applied into the circuit block 62, and the circuit block 62 is not damaged by the ESD pulse.

On the other hand, when the circuit block 62 is active, that is, the power voltage is supplied to the circuit block 62, the MEMS switch 1 as the ESD protection element 68 is turned off by supplying the driving potential Vg to the control terminal of the switch (the cap 20). In consequence, the ESD protection element 68 is electrically separated from the circuit block 62.

As described above, the ESD protection element using the MEMS switch of the present example holds the on-state when the IC chip (the circuit block) is non-active, and holds the off-state when the IC chip (the circuit block) is active.

In a case where the normally-on type MEMS switch 1 shown in, for example, FIGS. 1A to 1C is used in the ESD protection element 68 as in the present example, when no driving voltage is supplied to the gate of the MEMS switch, the switch is turned on. That is, even when the whole chip is electrically separated from the power supply, the normally-on type MEMS switch 1 can hold the on-state.

There is a high possibility that the ESD pulse is generated by the electrostatic charging of the constituent members of the chip in a step of mounting the chip on the circuit substrate or a step of testing a semiconductor device. On the other hand, while a packaged chip is incorporated in an electronic device, the breakdown of the IC chip (the circuit block 62) by the ESD pulse noticeably decreases. When the power voltage is supplied to the chip and electronic device, the breakdown of the chip by the ESD pulse further decreases. That is, there is a high possibility that the ESD pulse is generated when any power voltage is not supplied to the IC chip (the circuit block 62).

Thus, the ESD pulse is easily generated when the IC chip and the circuit block 62 of the chip are electrically separated from the power supply, and hence the normally-on type MEMS switch 1 which does not require any power voltage for holding the on-state as shown in FIGS. 1A to 1C is very effectively used in the ESD protection element 68. In consequence, during the generation of the ESD pulse, the MEMS switch 1 does not require any switching operation, and hence the switching of the MEMS switch and the speed of the switching do not adversely affect the protection from the ESD.

Moreover, the ESD protection element 68 using the MEMS switch 1 does not include any PN junction (diffusion layer) formed in the semiconductor substrate, and hence has a small parasitic capacity as compared with an ESD protection element using a resistor, a diode or a transistor. Furthermore, when the circuit block 62 is active, the MEMS switch 1 is turned off, and the MEMS switch 1 is electrically separated from the signal line 72.

Therefore, the ESD protection element 68 using the MEMS switch 1 does not cause any interconnection delay of the circuit block 62 due to the parasitic capacity or the leakage, and the input/output of data or command in/from the circuit block 62 can be speeded up.

Moreover, the MEMS switch 1 having the off-state has substantially no leakage. Therefore, the ESD protection element 68 using the MEMS switch 1 does not cause a decrease in the power voltage with respect to the circuit block 62. Furthermore, the MEMS switch 1 of FIGS. 1A to 1C has an electrostatic driving system, and hence the driving potential for holding the off-state is also low. Therefore, a large increase in the power consumption of the whole chip is not caused.

As described above, when the MEMS switch 1 is used as the ESD protection element 68, the power consumption can be decreased, and the breakdown of the circuit block 62 by the ESD can be prevented without deteriorating the performance of the circuit block 62. Therefore, there can be provided an ESD protection element of an MEMS structure having a high performance and a low power consumption.

Note that the ESD protection element 68 of the present example is effective against all the ESD of a human body model (HBM), a machine model (MM) and a charged device model (CDM).

### (2) Example 2

One example of an ESD protection element using an MEMS switch will be described with reference to FIG. 10. FIG. 10 is a block diagram showing the more specific constitution of an ESD protection element 68 using the MEMS switch and a device to be protected.

As shown in FIG. 10, a power potential VDD and a ground potential VSS are supplied to a circuit block 62 via pads 71, 74.

An ESD protection element 68X using a PN junction is provided between the power potential VDD and the ground potential VSS. This is because in a case where the ESD protection element using a normally-on type MEMS switch is provided between the power potential VDD and the ground potential Vss, short-circuit occurs between the power potential and the ground potential owing to the MEMS switch having the on-state, and no potential for turning off the MEMS switch con be generated.

The ESD protection element 68X using the PN junction is connected in series between the pad 71 to which the power voltage is supplied and the pad 74 to which the ground potential is supplied. The ESD protection element 68X using the PN junction is, for example, a diode. This diode 68X has a cathode connected to the pad (the power supply terminal) 71 and an anode connected to the pad (the ground terminal) 74. However, this ESD protection element 68X is not limited to a diode, and needless to say, an ESD protection element using a transistor may be used.

In the present example, an ESD protection element (in the present example, the diode) using a PN junction is provided between the power potential VDD and the ground potential VSS. The parasitic capacity of this ESD protection element 68X is larger than that of the MEMS switch, but the parasitic capacities of an interconnection to which the power potential VDD is supplied and an interconnection to which the ground potential VSS themselves are large, whereby the ESD protection element 68X has only little influence on the operation of the IC chip (the circuit block 62).

A power-on detecting circuit 67A is connected to the pad 71 to which the power potential VDD is supplied. The power-on detecting circuit 67A detects the introducing situation of the power potential VDD with respect to the chip (the circuit block 62), and outputs a power-on detecting signal SPO to a potential generation circuit (control circuit) 67B.

The potential generation circuit 67B is connected to the power-on detecting circuit 67A. The potential generation circuit 67B generates a driving potential Vg of the MEMS switch 1 as the ESD protection element 68 based on the power-on detecting signal SPO.

The normally-on type MEMS switch 1 as the ESD protection element 68 is an MEMS switch having a structure shown in, for example, FIGS. 1A to 10. The control terminal (the cap 20) of the normally-on type MEMS switch 1 is connected to the potential generation circuit 67B.

One end (the second port) of the MEMS switch 1 is connected to a current path (the signal line) of the pad 70 for the input/output of the signal and an input/output portion of the circuit block 62, and the other end (the first port) of the MEMS switch 1 is connected to the pad 74 via an interconnection 73.

As shown in FIG. 10, the diode (the ESD protection element) 68X is interposed between the power potential VDD and the ground potential Vss, whereby there is no short-circuit between two power supplies due to the ESD protection element 68 using the normally-on type MEMS switch. Therefore, the operation (on/off) of the normally-on type MEMS switch can be controlled by using the power potential VDD common to the IC chip (the circuit block 62).

The operation of the chip including the ESD protection element using the MEMS switch shown in FIG. 10 is as follows. Note that before the power potential is introduced, that is, when the chip is non-active, the MEMS switch of the ESD protection element has an on-state. This is similar to the operation described with reference to FIG. 9, and hence a detailed description thereof is omitted.

On detecting that the power is introduced to the IC chip (the circuit block 62) via the interconnection (a high potential power interconnection), the power-on detecting circuit 67A outputs the power-on detecting signal SPO to the potential generation circuit 67B. When the power potential VDD is introduced, the IC chip (the circuit block 62) becomes active.

The potential generation circuit 67B, in which the power-on detecting signal is input, generates the driving potential Vg of the MEMS switch 1. Then, the generated potential Vg is supplied to a control terminal of the MEMS switch 1. Note that the size of the driving potential Vg may be equal to or different from that of the power potential VDD.

Due to the generated potential Vg, the normally-on type MEMS switch 1 as the ESD protection element 68 is turned off. That is, the MEMS switch 1 is electrically separated from the signal line 72. In consequence, the input/output of the signal is executed between the circuit block 62 and the pad 70.

As described above, the on/off operation of the ESD protection element 68 using the normally-on type MEMS switch is controlled.

As described above, the normally-on type MEMS switch 1 shown in FIGS. 1A to 1C does not require any potential for holding the on-state of the switch, and the potential for holding the off-state of the switch is also small. Therefore, the ESD protection element with a small power consumption can be provided.

Moreover, according to the constitution shown in FIG. 10, MEMS switches 1 as the ESD protection elements 68 can further decrease the parasitic capacity in the off-state, and do not cause any distortion with respect to the elements and the IC chip (the circuit block 62). Therefore, according to a constitution in which the ESD protection element 68 using the MEMS switch is mounted in the chip as in the present example, the switch is especially effective for a high speed IC, a high speed memory and an RF-CMOS chip.

Therefore, an effect similar to that of the ESD protection element 68 using the MEMS switch described with reference to FIG. 9 is obtained, and the ESD protection element of an MEMS structure having a high performance and a low power consumption can be provided.

### (3) Example 3

### (a) Structure

One example of the ESD protection element using an MEMS switch will be described with reference to FIGS. 11, 12A and 12B. FIG. 11 shows a plan view of an ESD protection element 68 using the MEMS switch, and FIGS. 12A and 12B show sectional views of the ESD protection element using the MEMS switch.

The MEMS switch used in the ESD protection element 68 shown in FIGS. 9 and 10 may be of a normally-on type, and is not limited to the MEMS switch shown in FIGS. 1A to 1C. As shown in, for example, FIGS. 11, 12A and 12B, a normally-on type MEMS switch 4 driven by an actuator 9 may be used in the ESD protection element 68.

The ESD protection element 68 shown in FIGS. 11, 12A and 12B uses the normally-on type MEMS switch 4 of an electrostatic driving system in the same manner as in the ESD protection element shown in FIG. 9. This MEMS switch is driven in an on-state or an off-state by the actuator 9.

The structure of the MEMS switch will be described with reference to FIGS. 11, 12A and 12B.

MEMS switch 4 as the ESD protection element, a circuit block (ESD protection target circuit) 62 to be protected from ESD, as various interconnections 72, 73 and 35, pads 70, 74 and 76 are provided on a substrate 100. To the interconnection (the signal line) 72, a signal potential Vsig is supplied via the pad (the input/output terminal) 70. Moreover, to the interconnection (the ground line) 73, a ground potential Vgnd is supplied via the pad (the ground terminal) 74.

A beam portion constituting a movable structure 90 is connected to anchors 94A, 94B via torsion bars 93A, 93B. A conductor are used in the movable structure 90, the torsion bars 93A, 93B and the anchors 94A, 94B.

The one anchor 94A of the two anchors 94A, 94B is connected to the pad 74 via the interconnection 73. The ground line 73 and the ground terminal 74 correspond to one electrode (the first port) of the MEMS switch. The other anchor 94B is disposed on a dummy interconnection. Note that the ground terminal 74 may be shared by the MEMS switch 4 (the ESD protection element 68) and the circuit block 62, or ground terminals may separately be provided.

The tip of the movable structure 90 on a signal line 72 side is provided with a contact portion 91.

The contact portion 91 is disposed above the signal line 72, and warps toward the signal line 72.

The planar shape of the contact portion 91 includes, for example, a tip having a pointed shape, and is a hooked shape. According to such a planar shape, the contact resistance of the contact portion 91 can be decreased, and the loss of the MEMS switch can be decreased. Note that the number of the contact portions 91 may be one, two or more.

As the material of the contact portion 91, the same conductor as that of the movable structure is used. However, when the MEMS switch is applied to the ESD protection element, as the material of the contact portion 91, for example, gold (Au), aluminum (Al) and alloy including Al may be used. Al and an alloy of Al are formed into a natural oxidation film on its surface, but a stress voltage due to an ESD pulse causes a fritting phenomenon in which the natural oxidation film breaks down (dielectric breakdown). Due to this phenomenon, an ohmic contact between the contact portion 91 and the electrode (the interconnection) is realized. As suggested herein, the ESD protection element 68 using the normally-on type MEMS switch does not have to have a fully on-state when the IC chip is non-active. That is, the MEMS switch only need to be in a low impedance state in which the MEMS switch (the ESD protection element 68) immediately turns on when the chip is in a non-active state and the ESD pulse is applied. For a similar reason, in the non-active state of the chip, even in a case where the contact portion 91 is disposed a little away from an electrode (the signal line 72, when the ESD pulse is applied, the contact portion 91 immediately comes into contact with the electrode (the signal line 72), and the MEMS switch 4 may have an on-state.

However, to decrease a parasitic capacity in the active state of the IC chip, a space between the contact portion 91 and the electrode (the signal line 72) in the active state of the chip needs to be larger than a space between the contact portion 91 and the electrode in the non-active state thereof. This means that in the active state of the IC chip, the MEMS switch has a high impedance state.

As described above, the required conditions of the MEMS switch which functions as the ESD protection element 68 are that the switch has a high impedance state when the IC chip (or the circuit block) is active and that the switch has a low impedance state when the IC chip is non-active.

In the example shown in FIG. 11, the signal line 72 as the electrode (the second port) of the MEMS switch 4. Note that the electrode (the terminal) which functions as the second port may be an electrode separately drawn from the signal line 72, as long as the drawn electrode is in contact with the contact portion 91.

The warping of the contact portion 91 is realized by a regulation film 95 on the movable structure (the beam) 90. The regulation film 95 uses, for example, an insulator, and is provided so as to cover the contact portion 91. The regulation film 95 has a compressive internal stress larger than that of the movable structure 90 and the contact portion 91. Due to this different stress value between the regulation film 95 and the contact portion 91, the contact portion 91 (the tip of the movable structure 90) warps downwards. Note that when the regulation film 95 can impart a compressive internal stress to the contact portion 91, the material of the regulation film 95 is not limited to an insulator.

The electrostatic actuator 9 is provided at the end of the movable structure 90 on a side opposite to the contact portion 91 side. The electrostatic actuator 9 has two spring structures 97A, 97B, an upper electrode 98A and a lower electrode 98B.

The upper electrode 98A is connected to the movable structure 90 via the two spring structures 97A, 97B. The material of the upper electrode 98A is, for example, a conductor.

When the spring structures 97A, 97B are made of a conductor, a potential Vsa supplied to the upper electrode 98A is supplied from the ground line 73 via the movable structure 90. Therefore, the potential Vsa of the upper electrode 98A has a size substantially equal to that of a potential Vgnd of the ground line 73.

The lower electrode 98B is provided on the substrate 100. The surface of the lower electrode 98B is provided with an insulating film 79, and the upper electrode 98A is in contact with the lower electrode 98B via this insulating film 79.

The lower electrode 98B is connected to the pad 76 via the interconnection 75. To the pad 76, a potential Vga for driving the actuator 9 is supplied. As the material of the lower electrode 98B, for example, the same material (the conductor) as that of the interconnection 75 is used.

On the upper electrode 98A of the electrostatic actuator 9, an insulating film 99 is provided. This is provided to tilt the upper electrode 98A on a lower electrode 98B side and to narrow a space between the upper electrode 98A and the lower electrode 98B and to decrease the driving voltage of the actuator 9. In this case, a space between the upper electrode 98A and the lower electrode 98B broadens toward a movable structure 90 side.

In a portion (hereinafter referred to as the spring portion) 96 of the movable structure 90 from the torsion bars 93A, 93B to the spring structures 97A, 97B, the spring constant (a spring constant k1) of the spring portion 96 is larger than the spring constant (a spring constant k2) of the spring structures 97A, 97B. To increase the spring constant k1 of the spring portion 96, for example, the dummy metal 79 is provided on the substrate 100 under the movable structure 90.

The actuator 9 moves the movable structure 90 by the electrostatic attraction generated by a potential difference (|Vga−Vsa|) between the upper electrode 98A and the lower electrode 98B.

In the MEMS switch 4 of the present example, when the actuator 9 is not driven, that is, when the potential difference between the upper electrode 98A and the lower electrode 98B is substantially 0 V, the contact portion 91 is in contact with the signal line 72 as the electrode (the port). At this time, the MEMS switch 4 (the ESD protection element 68) has an on-state. Moreover, when the potential difference between the upper electrode 98A and the lower electrode 98B is larger than a pull-in voltage Vpia of the actuator 9, the contact portion 91 is electrically separated from the signal line 72. At this time, the MEMS switch 4 (the ESD protection element 68) has an off-state.

Thus, the MEMS switch 4 of the present example is a normally-on type MEMS switch.

### (b) Operation

The operation of the ESD protection element using the MEMS switch of the present example will be described with reference to FIGS. 12A and 12B. FIG. 12A shows a sectional structure when the MEMS switch 4 (the ESD protection element 68) has the on-state, and FIG. 12B shows a sectional structure when the MEMS switch 4 (the ESD protection element 68) has the off-state. Note that the operation of the whole chip is similar to that in the example described with reference to FIGS. 9 and 10, and hence a detailed description thereof is omitted here.

As shown in FIG. 12A, when the IC chip (the circuit block 62) is non-active, the potential difference (|Vga−Vsa|) between the upper electrode 98A and the lower electrode 98B constituting the actuator 9 is substantially set to 0 V. Therefore, the contact portion 91 warps downwards, and hence the contact portion 91 comes into contact with the signal line 72. That is, the MEMS switch 4 is held in the on-state even when there is no driving potential. Note that the contact portion 91 may be disposed a little away from the signal line 72. This is because when the ESD pulse flows through the signal line 72, due to the potential difference between the signal line 72 and the contact portion 91, electrostatic attraction is generated between the signal line 72 and the contact portion 91, and the MEMS switch 4 turns on by the electrostatic attraction.

When the potential Vsig of the signal line 72 is much larger than the ground potential Vgnd of the ground line owing to ESD, an ESD pulse is generated. In the present embodiment, the MEMS switch 4 has an on-state (a low impedance state), and the signal line 72 and the ground line 73 conduct. Therefore, the generated ESD pulse and a current caused by the pulse are discharged from the signal line 72 to the ground line 73 via the contact portion 91, the movable structure 90 and the torsion bars 93A, 93B.

Therefore, the ESD pulse does not flow into the circuit block 62, but is discharged to the ground terminal 74.

As shown in FIG. 12B, when the circuit block 62 is active, the contact portion 91 and the signal line 72 are brought into a non-contact state, that is, the MEMS switch 4 is turned off. This specific operation is as follows.

To the lower electrode 98B, the driving potential Vga of the actuator 9 is supplied via the pad 76 and the interconnection 75. On the other hand, to the upper electrode 98A, the potential Vsa (e.g., the ground potential Vgnd) is supplied.

As described above, the spring constant k1 of the spring portion 96 is larger than the spring constant k2 of the spring structures 97A, 97B. Therefore, when the potential difference (|Vga−Vsa|) between the upper electrode 98A and the lower electrode 98B in the electrostatic actuator 9 is larger than such a pull-in potential Vpia of the actuator 9 so as to attract the upper electrode 98A to a lower electrode 98B side, the spring structures 97A, 97B are noticeably deformed as compared with the spring portion 96, and the contact portion 91 floats upwards in a seesaw manner around the torsion bars 93A, 93B as a rotation axis. In consequence, the ESD protection element 68 using the MEMS switch 4 is brought into the off-state (the high impedance state) when the circuit block 62 is active.

As described above, the MEMS switch 4 as the ESD protection element is turned on when the IC chip (the circuit block 62) is non-active, and is turned off when the IC chip (the circuit block 62) is active.

As described with reference to FIGS. 11, 12A and 12B, the structure and specific operation of the normally-on type MEMS switch 4 used in the ESD protection element 68 are different from those of the normally-on type MEMS switch used in the ESD protection element 68 described with reference to FIGS. 1A to 10 and FIG. 9.

However, also in the present example, the MEMS switch 4 used in the ESD protection element is of the normally-on type and operates by an electrostatic driving system. Therefore, even in the ESD protection element using the MEMS switch 4 of the present example, the driving potential for holding the on-state of the element is not required, and the power consumption for holding the off-state of the element is small.

Therefore, the same effect as that of the ESD protection element 68 described with reference to FIGS. 1A to 10 and FIG. 9 is obtained, and an ESD protection element of the MEMS structure having a high performance and a low power consumption can be provided.

### (4) Example 4

One example of an ESD protection element using an MEMS switch will be described with reference to FIGS. 13A and 13B. In an ESD protection element 68 shown in FIGS. 13A and 13B, a normally-on type MEMS switch 5 is used. However, this MEMS switch 5 is different from the MEMS switch described in Examples 1, 2 and 3 in that the switch is a thermal driving system.

(a) Structure

FIG. 13A shows a plan view of the ESD protection element 68 using the MEMS switch 5 of the present example, and FIG. 13B schematically shows the sectional structure of the ESD protection element using the MEMS switch 5 of the present example.

In the MEMS switch 5 shown in FIGS. 13A and 13B, a movable structure 80 has a V-shaped planar shape. The tip of this V-shape is a contact portion 81.

Portions branched from the V-shaped tip (the contact portion 81) in two directions are connected to anchors 82A, 82B, respectively. The movable structure 80 is supported by the two anchors 82A, 82B. The movable structure 80 and the anchors 82A, 82B are made of a conductor.

The anchor 82A is disposed on a ground line 73.

To this anchor 82A, a ground potential Vgnd is supplied via a pad 75.

The anchor 82B is disposed on an interconnection 74. To this anchor 82B, a driving potential Vg of the MEMS switch 5 is supplied via a pad 76.

The contact portion 81 is provided at the tip of the V-shaped movable structure 80, and is disposed above a signal line 72. The planar shape of the contact portion 81 has a pointed tip, and is a hooked shape. Moreover, the contact portion warps to a signal line 72 side (downwards). This warping of the contact portion 81 is obtained by a regulation film 85 provided on the upper surface of the movable structure 80. The regulation film 85 has a compressive internal stress larger than that of the movable structure 80.

Moreover, as described above, the MEMS switch 5 of the present example is of a thermal driving type. Therefore, in the movable structure 80 and the contact portion 81, a material having a thermal expansion ratio larger than that of the regulation film 85 is used. Note that in general, the thermal expansion coefficient of the conductor is larger than that of the insulating film. In the present example, the regulation film 85 uses an insulator, but there is no special restriction on the material as long as the internal stress and thermal expansion ratio of the regulation film 85 satisfy the above conditions of the internal stresses and thermal expansion ratios of the movable structure 80 and contact portion 81.

In the normally-on type MEMS switch 5 of the thermal driving system of the present example, a potential difference (|Vg−Vgnd|) between the two anchors 82A and 82B is set to a value larger than a predetermined potential to pass a current through the movable structure 80, and due to a thermal function caused by the current, the MEMS switch 5 is turned off. Note that this MEMS switch 5 is turned on by setting the potential difference between the two anchors 82A and 82B to substantially 0 V.

(b) Operation

The operation of the ESD protection element 68 using the MEMS switch 5 of the present example will be described with reference to FIG. 13B. Note that FIG. 13B schematically shows the sectional structure of the MEMS switch 5 in an on/off state. Note also that the operation of the whole chip is similar to that of the example described with reference to FIGS. 9 and 10, and hence a detailed description thereof is omitted here.

As shown in FIG. 13B, when an IC chip (a circuit block 62) is non-active, in the MEMS switch 5 of the present example, the signal line 72 is in contact with the contact portion 81 by the warping of the contact portion 81 due to the internal stress of the regulation film 85. Therefore, the MEMS switch 5 (the ESD protection element 68) has an on-state even when no driving potential is present.

Moreover, when an ESD pulse is supplied to the signal line 72, the ESD pulse is discharged to the ground line 73 via the MEMS switch 5 as the ESD protection element 68. Therefore, the IC chip (the circuit block 62) is not damaged by the ESD pulse.

When the IC chip (the circuit block 62) is active, the potential difference (|Vg−Vgnd|) of a predetermined value or more is supplied between the two pads 75 and 76 shown in FIG. 13A. Then, a current Ia flows into the movable structure 80, and due to this current Ia, the movable structure 80 generates heat.

When the thermal expansion ratio of the movable structure 80 is larger than that of the regulation film 85, the movable structure 80 causes such a shape change as to cancel the compressive internal stress due to the regulation film 85 owing to the difference of the thermal expansion ratio. Due to the shape change due to this thermal expansion, the movable structure 80 moves upwards with respect to the signal line 72, and the contact portion 81 comes away from the signal line 72.

Moreover, as described above, there is a high probability of the ESD pulse being generated in the manufacturing steps of the chip, and a very low probability of generation during the actual use of the IC chip (the circuit block 62). Therefore, after the manufacturing steps, an excessively large current is passed through the MEMS switch 5, and the movable structure 80 is heated and irreversibly plastically changed, whereby the off-state of the MEMS switch 5 may be held. In consequence, to hold the MEMS switch 5 in the off-state, no driving potential is necessary, and in addition to a decrease in the power consumption in the on-state (during ESD protection), the power consumption can be decreased also in the off-state of the MEMS switch 5. Moreover, the ESD protection element 68 using the MEMS switch 5 is completely electrically separated from the IC chip (the circuit block 62), and hence does not have any adverse influence on the IC chip during the actual use thereof.

Thus, when the IC chip (the circuit block 62) is active, a current for changing the shape of the movable structure 80 is supplied from the one end (the anchor 82B) to the other end (the anchor 82A) of the movable structure, thereby turning off the MEMS switch. In consequence, the ESD protection element 68 is electrically separated from the circuit block 62.

Further in the ESD protection element 68 using the normally-on type MEMS switch 5 of the thermal driving system as in the present example, the MEMS switch 5 as the ESD protection element is turned on when the IC chip (the circuit block 62) is non-active, and is turned off when the IC chip (the circuit block 62) is active.

Therefore, an effect similar to that in Examples 1, 2 and 3 described above, and an ESD protection element using the MEMS structure having a high performance and a low power consumption can be provided.

### (5) Example 5

One example of an ESD protection element using the MEMS switch will be described with reference to FIG. 14. FIG. 14 is a block diagram showing the constitution of an ESD protection element 68 of the present example.

In the example described with reference to FIGS. 9 to 13B, a constitution has been described in which an IC made of a transistor is protected from an ESD pulse by the ESD protection element using a normally-on type MEMS switch. However, needless to say, the ESD protection element using the MEMS switch of each example may be used to protect an MEMS device from ESD.

In, for example, FIG. 14, in the ESD protection element 68 using a normally-on type MEMS switch 1, an RF-MEMS device 69 as the MEMS device is a target of ESD protection. The RF-MEMS device 69 outputs a high frequency (radio frequency: RF) in accordance with the operation of the device.

One end of the RF-MEMS device 69 is connected to a signal line 72, and the other end of the RF-MEMS device 69 is connected to a ground line 73. Moreover, to connect the ESD protection element 68 in parallel with the RF-MEMS device 69, the one end and other end of the ESD protection element 68 are connected to the signal line 72 and the ground line 73, respectively.

The ESD protection element 68 using the normally-on type MEMS switch 1 has an on-state when the RF-MEMS device 69 is non-active. Moreover, the ESD protection element 68 is turned off when the RF-MEMS device 69 is active.

Further, the ESD protection element 68 using the normally-on type MEMS switch 1 can protect the RF-MEMS device 69 to be protected from the ESD pulse. Therefore, an ESD protection element which uses an MEMS structure having a high performance and a low power consumption can also be provided by the present example in the same manner as in Examples 1 to 4.

Note that, in the present example, an RF-MEMS device is the target of ESD protection, but needless to say, a similar effect can be obtained even in another device using a MEMS structure. Moreover, in the present example, as the MEMS switch as the ESD protection element 68, needless to say, the MEMS switches 4, 5 shown in FIGS. 11 and 13A may be used.

### (6) Conclusion

As described above, in the second embodiment of the present invention, the normally-on type MEMS switch is applied to the ESD protection element as described in Examples 1 to 5.

Moreover, when no power voltage is supplied to the circuit (the IC or the MEMS device) as the target of ESD protection (non-active state), the MEMS switch as the ESD protection element is turned on (low impedance state). On the other hand, when the power voltage is supplied to the circuit as the target of ESD protection (active state), the MEMS switch as the ESD protection element is turned off (high impedance state).

In consequence, when the circuit is non-active and the probability of generation of an ESD pulse is high, the ESD protection element 68 using the MEMS switch does not require any driving potential, but can hold the on-state. In this case, since the MEMS switch holds the on-state, there is no adverse influence on the switching.

Moreover, when the circuit as the target of the ESD protection is active, the ESD protection element 68 using the MEMS switch is turned off. Since the MEMS switch causes substantially no leakage, the corresponding ESD protection element can substantially completely electrically be separated from the IC chip (the circuit block), and the generation of a voltage decrease and delay with respect to the circuit can be decreased.

As described above, according to the second embodiment of the present invention, the power consumption of the ESD protection element can be decreased, and any adverse influence on the circuit can be decreased.

Therefore, an ESD protection element using a MEMS structure having a high performance and low power consumption can be provided.

[Others]

The examples of the present invention are not limited to the above embodiment, and the respective constituent elements can be changed and embodied without departing from the scope of the present invention. Moreover, by the appropriate combination of a plurality of constituent elements described in the above embodiments, various inventions can be achieved. For example, several constituent elements may be deleted from all the constituent elements described in the above embodiment, and the constituent elements of different embodiments may appropriately be combined.

What is claimed is:

1. A switch comprising:
first and second electrodes provided on a substrate;
an anchor provided on the first electrode;
a movable structure of which a first end is supported by the anchor, extending from the anchor to a position above the second electrode, using a conductor, and configured to move in a vertical direction with respect to the second electrode;
a contact portion provided at a second end of the movable structure and disposed above the second electrode;
a film having a different stress value with respect to the stress value of the movable structure, and warping the contact portion toward the second electrode; and
a cap provided on the substrate to cover the movable structure, configured to be in contact with the film, and functioning as a driving electrode.

2. The switch of claim 1, wherein the movable structure has a convex portion having a convex shape on a cap side in a sectional shape of the movable structure.

3. The switch of claim 1, wherein when a potential difference between the first electrode and the cap is substantially 0 V, the contact portion is in contact with the second electrode, and
when the potential difference between the first electrode and the cap is not less than a potential difference at which the movable structure starts to move, the contact portion is not in contact with the second electrode.

4. The switch of claim 1, wherein the film is provided on the movable structure, the compressive internal stress of the film is larger than that of the movable structure.

5. The switch of claim 1, wherein the cap has:
a first layer which is in contact with the film and which is made of an insulator; and
a second layer which is laminated on the first layer, which is made of a conductor and to which a potential is supplied.

6. The switch of claim 2, wherein the film is provided on the convex portion, the film on the convex portion is in contact with the cap.

7. The switch of claim 1, further comprising:
a third electrode which is provided on the substrate and which supplies a potential to the cap.

8. The switch of claim 1, the substrate having:
a switch region in which the movable structure and the second electrode is provided; and
a circuit region positioned in a lower layer below the switch region and in which a circuit driven by a power voltage supplying from a power supply is provided,
wherein the movable structure and the second electrode connected between the circuit and the power supply,
when the circuit is non-active, the contact portion is not in contact with the second electrode.

9. A switch comprising:
first and second electrodes provided on a substrate;
a third electrode provided on the substrate and between the first electrode and the second electrode;
an anchor provided on the first electrode;
a movable structure of which a first end is supported by the anchor, extending from the anchor to a position above the second electrode, using a conductor, and configured to move in a vertical direction with respect to the second electrode;
a contact portion provided at a second end of the movable structure and disposed above the second electrode;
a first film provided on the upper surface of the movable structure, the first film having a different stress value with respect to the stress value of the movable structure, and warping the contact portion toward the second electrode;
a second film provided on the bottom surface of the movable structure, the second film having a different stress value with respect to the stress value of the movable structure, warping the movable structure toward the third electrode and configured to be in contact with the third electrode; and
a cap provided on the substrate to cover the movable structure and being into contact with the first film.

10. The switch of claim 9, wherein the movable structure has a convex portion having a convex shape on a cap side in a sectional shape of the movable structure.

11. The switch of claim 9, wherein when a potential difference between the movable structure and the third electrode is substantially 0 V, the contact portion is not in contact with the second electrode, and
when the potential difference between the movable structure and the third electrode is not less than a potential difference at which the movable structure starts to move, the contact portion is in contact with the second electrode.

12. The switch of claim 9, wherein the compressive internal stresses of the first and second films are larger than the compressive internal stress of the movable structure.

13. An ESD protection element comprising:
a first terminal provided on a substrate of an IC chip and connected to a first interconnection which is connected to a device to be protected; and
a switch provided on the substrate between the first terminal and a second interconnection and including a movable structure,
wherein when the IC chip is non-active, the switch has a low impedance state, and
when the IC chip is active, the switch has a high impedance state.

14. The ESD protection element of claim 13, wherein the switch further comprises:
a first electrode connected to the first terminal;
at least one anchor provided on the substrate; connected to the second interconnection and supporting the movable structure;
a contact portion provided at the end of the movable structure and disposed above the first electrode; and
a film provided on the movable structure, the film having a different stress value with respect to the stress value of the movable structure, and warping the contact portion toward the first electrode,
wherein the movable structure is a conductor, extends from the anchor above the first electrode and configured to move in a vertical direction with respect to the first electrode.

15. The ESD protection element of claim 14, wherein the switch further comprises:
a torsion bar interposed between the movable structure and the anchor;
a spring structure connected to the movable structure and having a spring coefficient smaller than that of the movable structure;
an upper electrode connected to the movable structure via the spring structure; and
a lower electrode provided on the substrate.

16. The ESD protection element of claim 15, the movable structure has a convex portion having a convex shape on opposite to a first electrode in a sectional shape of the movable structure.

17. The ESD protection element of claim 13, wherein the switch further comprises:
a first electrode connected to the first terminal;
at least one anchor provided on the substrate, connected to the second interconnection and supporting the movable structure;
a contact portion provided at the end of the movable structure and disposed above the first electrode; and
a film provided on the movable structure and having a thermal expansion coefficient smaller than that of the movable structure,
wherein the movable structure is a conductor, extends from the anchor above the first electrode and moves in a vertical direction with respect to the first electrode.

18. The ESD protection element of claim 17, wherein the movable structure moves in the vertical direction with respect to the first electrode due to the heat caused by a current supplied from the second interconnection.

19. The ESD protection element of claim 13, further comprising:
a detecting circuit configured to detect whether the IC chip is active or non-active; and
a control circuit configured to control the switch in a high impedance state or a low impedance state based on the detection result of the detecting circuit.

20. The ESD protection element of claim 13, further comprising:
a MEMS device which is connected to the first interconnection,
wherein the switch functions as a protection element to the MEMS device.
